(19) United States
(12) Patent Application Publication
(10) Pub. No.: US 2025/0061916 A1
(43) Pub. Date: Feb. 20, 2025

(54) NEURAL ACOUSTIC MODELING FOR AN AUDIO ENVIRONMENT

(71) Applicant: SHURE ACQUISITION HOLDINGS, INC., Niles, IL (US)

(72) Inventors: Paul Becke, Mundeleing, IL (US); Daniel Law, Glencoe, IL (US); Nathan Seitz, Austin, TX (US)

(21) Appl. No.: 18/806,864

(22) Filed: Aug. 16, 2024

Related U.S. Application Data
(60) Provisional application No. 63/519,959, filed on Aug. 16, 2023.

(51) Int. Cl. G10L 25/30; G06T 15/00

(52) U.S. Cl. CPC G10L 25/30; G06T 15/005

(57) ABSTRACT

Techniques are disclosed herein for providing neural acoustic modeling for an audio environment. Examples may include receiving audio data and image data associated with an audio environment, generating an image set comprising a plurality of images each associated with audio samples representing acoustic properties of the audio environment, and generating an audio rendering model for the audio environment based at least in part on the image set and the audio samples. The audio rendering model may include a neural rendering volumetric representation of the audio environment augmented with audio encodings.

### CROSS REFERENCE TO RELATED APPLICATIONS

This application claims the benefit of U.S. Provisional Patent Application No. 63/519,959, titled “NEURAL ACOUSTIC MODELING FOR AN AUDIO ENVIRONMENT,” and filed on Aug. 16, 2023, the entirety of which is hereby incorporated by reference.

### TECHNICAL FIELD

Embodiments of the present disclosure relate generally to audio processing and, more particularly, to systems configured to provide and/or utilize a neural acoustic modeling for an audio environment.

### BACKGROUND

A three-dimensional (3D) model of a scene (e.g., a room, building, city, or any other type of indoor or outdoor space) may be generated using multiple images captured from different viewpoints within the scene. However, 3D models of a scene typically lack functionality for audio attributes related to the scene.

### BRIEF SUMMARY

Various embodiments of the present disclosure are directed to apparatuses, systems, methods, and computer readable media for providing neural acoustic modeling for an audio environment. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example audio signal processing system using neural renderings and inferences in accordance with one or more embodiments disclosed herein;

FIG. 2 illustrates an example neural rendering processing apparatus configured in accordance with one or more embodiments disclosed herein;

FIG. 3 illustrates an example neural rendering model generation flow enabled by a neural rendering model generation engine in accordance with one or more embodiments disclosed herein;

FIG. 4 illustrates an example neural rendering model inference flow enabled by a neural rendering model inference engine in accordance with one or more embodiments disclosed herein;

FIG. 5A illustrates an example audio environment in accordance with one or more embodiments disclosed herein;

FIG. 5B illustrates another example audio environment in accordance with one or more embodiments disclosed herein;

FIG. 6 illustrates an example model in accordance with one or more embodiments disclosed herein;

FIG. 7 illustrates an example neural rendering flow enabled by a neural rendering system in accordance with one or more embodiments disclosed herein;

FIG. 8A illustrates an example neural rendering flow enabled by a neural rendering system in accordance with one or more embodiments disclosed herein;

FIG. 8B illustrates another example neural rendering flow enabled by a neural rendering system in accordance with one or more embodiments disclosed herein;

FIG. 8C illustrates yet another example neural rendering flow enabled by a neural rendering system in accordance with one or more embodiments disclosed herein;

FIG. 9 illustrates a training flow enabled by a neural rendering system in accordance with one or more embodiments disclosed herein;

FIG. 10 illustrates an inference flow enabled by a neural rendering system in accordance with one or more embodiments disclosed herein;

FIG. 11 illustrates an example method for providing neural acoustic modeling for an audio environment in accordance with one or more embodiments disclosed herein; and

FIG. 12 illustrates an example method for providing audio inferences using neural acoustic modeling for an audio environment in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

For certain types of audio systems, such as a conference room audio system, multiple audio capture devices may be arranged at different locations in an audio environment. However, it is often difficult to design, install, and/or set up audio capture devices in an audio environment such that an audio system provides desirable acoustic performance for the audio environment. For example, it may be desirable to add or improve multi-media capability to a meeting space to provide live streaming of audio and/or video with minimal disruption to the meeting space. As such, a technical expert may design, install, and/or set up audio/video equipment for live streaming by recording images and measurements of the meeting space to enable subsequent manual creation of drawings, blueprints, and/or acoustic performance estimates of the meeting space. This process involves manual conversion of the images and measurements into blueprints, which may lead to inaccuracies and/or inefficiencies for the audio system. Moreover, even with a technical expert, it is difficult to accurately estimate acoustic performance of the meeting space. Therefore, it is difficult to optimally arrange and/or configure audio capture devices in the meeting space to optimize performance of the audio system.

As discussed above, a three-dimensional (3D) model of a scene (e.g., a room, building, city, or any other type of indoor or outdoor space) may be generated using multiple images captured from different viewpoints within the scene. However, synthesis of a 3D model is typically based on visual attributes of a scene. As such, even with a typical 3D model of a scene, it is difficult to accurately estimate acoustic characteristics and/or performance of the scene. In addition, typical audio capture devices and/or other audio equipment are unable to measure or leverage precise spatial and acoustic understanding of audio environments. For example, different audio environments require different placement and configuration of audio capture devices and/or other audio equipment to provide desirable listening experiences at different locations within an audio environment. However, sound is transformed and propagated in a different manner depending on the audio environment.

Various examples disclosed herein provide for neural acoustic modeling for an audio environment. The neural acoustic modeling may provide an implicit representation of physical and acoustic characteristics of an audio environment. In some examples, the neural acoustic modeling may be based on a set of impulse response samples and a geometric representation of an audio environment. Additionally, the neural acoustic modeling may provide for rendering of environmental acoustic characteristics, acoustic properties, and/or acoustic simulation of an audio environment. In some examples, the neural acoustic modeling may be utilized in an acoustic rendering process to provide an acoustic simulation associated with a source-receiver location pair in an audio environment.

### Exemplary Neural Acoustic Modeling Systems and Methods

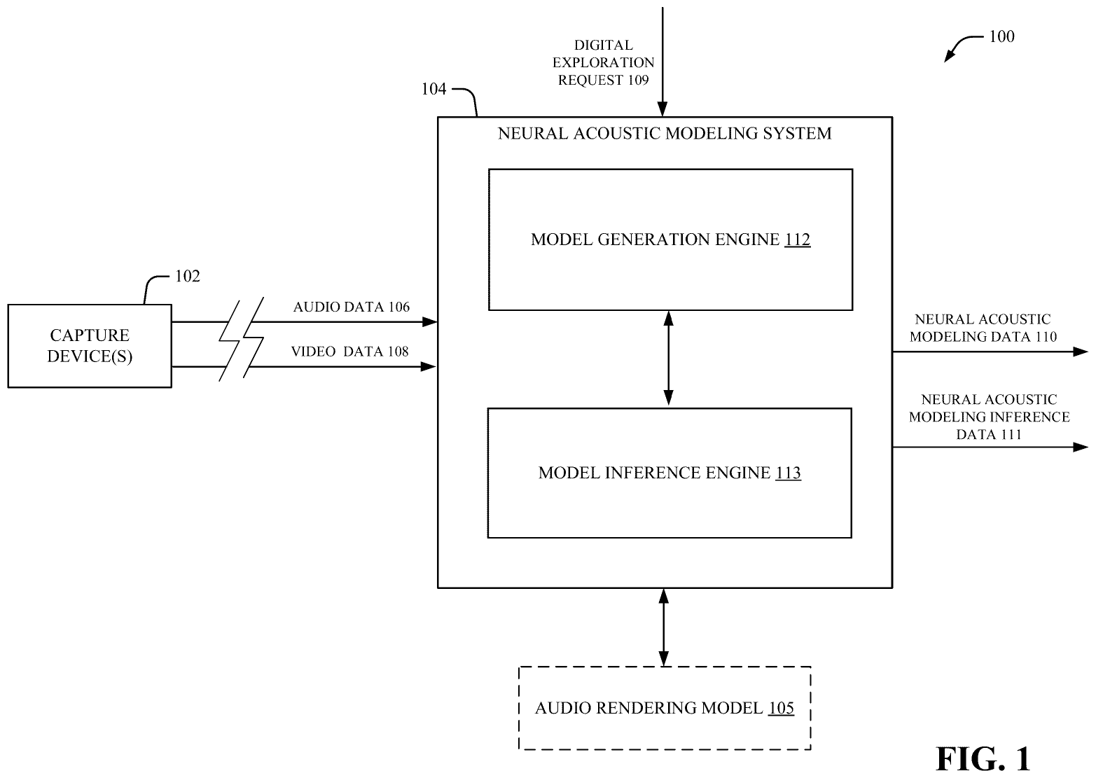

FIG. 1 illustrates an audio signal processing system 100 that is configured to provide for neural acoustic modeling for an audio environment, according to embodiments of the present disclosure. The audio signal processing system 100 may be, for example, a conferencing system (e.g., a conference audio system, a video conferencing system, a digital conference system, etc.), an audio performance system, an audio recording system, a music performance system, a music recording system, a digital audio workstation, a lecture hall microphone systems, a broadcasting microphone system, an augmented reality system, a virtual reality system, an online gaming system, or another type of audio system. Additionally, the audio signal processing system 100 may be implemented as an audio signal processing apparatus and/or as software that is configured for execution on a microphone, a smartphone, a laptop, a personal computer, a digital conference system, a wireless conference unit, an audio workstation device, an augmented reality device, a virtual reality device, a recording device, headphones, earphones, speakers, or another device. The audio signal processing system 100 disclosed herein may additionally or alternatively be integrated into a virtual DSP processing system (e.g., DSP processing via virtual processors or virtual machines) with other conference DSP processing.

The audio signal processing system 100 provides for neural acoustic modeling for an audio environment. The neural acoustic modeling may provide for rendering of environmental acoustic characteristics and/or acoustic simulation of an audio environment. In some examples, the neural acoustic modeling provides for rendering of environmental acoustic characteristics and/or acoustic simulation of an audio environment. In some examples, the neural acoustic modeling provides for volumetric audio simulation and rendering. In some examples, the neural acoustic modeling provides for precise 3D audio simulation and rendering. In some examples, the neural acoustic modeling provides for ray-traced neural acoustic modeling for volumetric audio simulation and rendering of the audio environment. Additionally, the neural acoustic modeling may be trained using neural radiance fields and augmented with acoustic properties and/or material features of an audio environment.

The neural acoustic modeling may be provided via an audio rendering model. The audio rendering model may provide a rendering of acoustic characteristics and/or acoustic properties of an audio environment. In some examples, the audio rendering model may be a neural acoustic model. In other examples, the audio rendering model may be an audio-visual rendering model that provides a rendering of visual characteristics and/or acoustic properties of the audio environment in combination with acoustic characteristics and/or acoustic properties of the audio environment. In some examples, the audio rendering model may be a neural radiance field (NeRF) model augmented with audio encodings or another type of 3D visualization model augmented with audio encodings. In some examples, the audio rendering model may be a multilayer perceptron (MLP) model that includes one or more non-linear activation functions. In some examples, input of the MLP model may be a positional encoding (e.g., a positional embedding, etc.). Additionally, output of the MLP model may be based on energy reflected and/or energy absorbed for each frequency band associated with a position in the audio environment corresponding to the inputted positional encoding.

In some examples, the audio rendering model may be configured with outputs to encode acoustic properties related to an audio environment. In some examples, photogrammetry may be utilized to estimate a relative 3D location (e.g., x, y, z coordinates) and orientation (e.g., pitch, yaw and roll) of captured images. The captured images along with the location and orientation data may then be utilized to train weights of the audio rendering model. The weights may encode spatial information related to the scene. For instance, the weights may be related to: respective locations of structures or objects within the scene, volume densities which represent a respective opacity of the structures or objects, color information such as RGB color related to the structures or objects, and/or other spatial data related to the scene. It is to be appreciated that the color information may be related to directionality with respect to an audio environment. For example, the audio rendering model may model color information (e.g., RGB color) in various directions from respective locations in the audio environment such that color may change depending on the direction. In some examples, the color information may be utilized to determine reflectivity or other characteristics of structure or objects. Once the audio rendering model is trained, the latent space as represented by the trained weights of the audio rendering model may be queried to infer views of the scene. As such, in addition to the visual attributes of an audio environment, the audio rendering model may expand encodings to include acoustic information related to the audio environment.

In some examples, the audio rendering model may be trained as a NeRF model or another 3D representation model augmented with audio encodings related to material properties. The augmented encodings may be utilized to capture locations of sound sources, attributes associated with the propagation of sound within an audio environment, acoustic attributes associated with specific objects within an audio environment, and/or other acoustic properties associated with the audio environment.

In some examples, measurements of the acoustics of an audio environment may be captured in conjunction with images of the audio environment. The acoustic measurements may then be correlated with visual views related to the images of the audio environment. In some examples, the acoustic measurements and/or other acoustic data may be correlated to point cloud locations, voxel grid locations, mesh locations, or other 3D representative locations of the neural rendering model. In some examples, the neural rendering model may query a trained NeRF model or other 3D representation of an audio environment to infer geometry of the audio environment with respect to propagation of sound within the audio environment. In some examples, a separate model (e.g., separate from the neural rendering model) may be trained to infer material properties of structures or objects that may be utilized to produce an acoustic transfer function, impulse response, or other audio rendering for the audio environment.

With the audio signal processing system 100, an audio system for an audio environment may be optimally designed, installed, arranged, and/or configured. For example, the audio signal processing system 100 may provide automated, augmented, and/or enhanced configuration of audio capture devices for an audio system. The audio signal processing system 100 may additionally or alternatively provide an optimal arrangement of the audio capture devices in the audio environment to provide optimal acoustic performance and/or computing performance for the audio system.

In some examples, the audio signal processing system 100 may be utilized to infer locations of audio sources and/or acoustic transfer functions that estimate transformation of audio as the audio propagates through an audio environment. For instance, acoustic transfer functions (e.g., impulse responses) may be inferred from a trained neural rendering model associated with the audio signal processing system 100 to enable one or more downstream audio applications for an audio environment. In some examples, a trained neural rendering model associated with the audio signal processing system 100 may be queried to support design and/or configuration of audio equipment within an audio environment.

In some examples, to provide an audio rendering model associated with the audio signal processing system 100, multiple audio capture devices may be positioned in an audio environment (e.g., without intelligent and/or expert positioning of the audio capture devices within the audio environment) to construct to the audio rendering model with a precise spatial and acoustic understanding of the audio environment. The audio rendering model associated with the audio signal processing system 100 may also allow adjustment of audio parameters to optimize audio experiences for the audio environment by leveraging a “mind's eye” view of the audio environment via the audio rendering model.

Additionally, the audio signal processing system 100 may utilize the neural acoustic modeling to provide various improvements related to audio processing such as, for example, to: optimally control and/or configure audio equipment in an audio environment, optimally arrange audio equipment in an audio environment, automatically track a sound source or emitted sound in an audio environment, reduce noise in an audio environment, and/or improve one or more other audio processes related to an audio system in an audio environment.

The audio signal processing system 100 may also be adapted to produce improved audio signals with reduced noise, reverberation, and/or other undesirable audio artifacts. In applications focused on reducing noise, such reduced noise may be stationary and/or non-stationary noise. Additionally, the audio signal processing system 100 may provide improved audio quality for audio signals in an audio environment. An audio environment may be an indoor environment, an outdoor environment, a room, a performance hall, a broadcasting environment, a sports stadium or arena, a virtual environment, or another type of audio environment. In various examples, the audio signal processing system 100 may be configured to remove or suppress noise, reverberation, and/or other undesirable sound from audio signals via digital signal processing. The audio signal processing system 100 may alternatively be employed for another type of sound enhancement application such as, but not limited to, active noise cancelation, adaptive noise cancelation, etc.

The audio signal processing system 100 includes one or more capture devices 102. The one or more capture devices 102 may respectively be audio capture devices configured to capture audio from one or more sound sources. The one or more capture devices 102 may include one or more sensors configured for capturing audio by converting sound into one or more electrical signals. The audio captured by the one or more capture devices 102 may also be converted into audio data 106. The audio data 106 may be a digital audio data or, alternatively, analog audio data, related to the one or more electrical signals.

The one or more capture devices 102 may additionally or alternatively be respective video capture devices configured to capture video and/or imagery related to the audio environment. The one or more capture devices 102 may include one or more sensors configured for capturing video and/or imagery by converting light into one or more electrical signals. The video and/or imagery captured by the one or more capture devices 102 may also be converted into video data 108. The video data 108 may be a digital video data and/or digital image data or, alternatively, analog video data and/or analogy image data, related to the one or more electrical signals. It is to be appreciated that the video data 108 may be represented as one or more images (e.g., image data) captured by the one or more capture device 102.

In some examples, the one or more capture devices 102 include one or more consumer cameras, smartphone cameras, 3D cameras, and/or another type of camera. A 3D camera may include, but is not limited to: LiDAR, RADAR, inertial measurement units (IMUs), magnetic field sensors, accelerometers, gyroscopes, or another type of sensor capable of capturing video, imagery, and/or position. In some examples, the video data 108 may be augmented with position and/or orientation data provided by a 3D camera.

In an example, the one or more capture devices 102 are one or more microphones arrays. For example, the one or more capture devices 102 may correspond to one or more array microphones, one or more beamformed lobes of an array microphone, one or more linear array microphones, one or more ceiling array microphones, one or more table array microphones, or another type of array microphone. In alternate examples, the one or more capture devices 102 are another type of capture device such as, but not limited to, one or more condenser microphones, one or more micro-electromechanical systems (MEMS) microphones, one or more dynamic microphones, one or more piezoelectric microphones, one or more virtual microphones, one or more network microphones, one or more ribbon microphones, and/or another type of microphone configured to capture audio. It is to be appreciated that, in certain examples, the one or more capture devices 102 may additionally or alternatively include one or more video capture devices, one or more image capture devices, one or more infrared capture devices, one or more sensor devices, and/or one or more other types of capture devices. Additionally, the one or more capture devices 102 may be positioned within a particular audio environment.

The audio signal processing system 100 also comprises a neural acoustic modeling system 104. The neural acoustic modeling system 104 may be configured to perform one or more modeling processes with respect to the audio data 106 and/or the video data 108 to provide neural acoustic modeling data 110. The neural acoustic modeling system 104 may additionally or alternatively be configured to perform one or more inference processes with respect to a digital exploration request 109 to provide neural acoustic modeling inference data 111.

The neural acoustic modeling system 104 depicted in FIG. 1 includes a model generation engine 112 and/or a model inference engine 113. The neural acoustic modeling system 104 utilizes the model generation engine 112 to generate, train, and/or retrain an audio rendering model 105 using the audio data 106 and/or the video data 108. The audio rendering model 105 may provide a rendering of acoustic characteristics and/or acoustic properties of the audio environment. In some examples, the audio rendering model 105 may be a neural acoustic model for the audio environment. For example, the audio rendering model 105 may be an implicit representation of physical and acoustic characteristics of the audio environment. In some examples, the audio rendering model 105 may be optimized from an impulse response set and a geometric representation of the audio environment. In some examples, the audio rendering model 105 may be a machine learning model such as a neural network model, a deep learning model, or another type of machine learning model.

In some examples, the audio rendering model 105 may be an audio-visual rendering model that provides a rendering of visual characteristics and/or acoustic properties of the audio environment in combination with acoustic characteristics and/or acoustic properties of the audio environment. In some examples, the audio rendering model 105 may be an augmented neural rendering model that includes a neural rendering volumetric representation of the audio environment augmented with audio encodings. For example, the audio rendering model 105 may be a NeRF model (e.g., an augmented NeRF model) or another type of 3D visualization model (e.g., an augmented 3D model) augmented with audio encodings.

In some examples, the audio rendering model 105 may be an MLP model that includes one or more non-linear activation functions. In some examples, input of the MLP model may be a positional encoding (e.g., a positional embedding, etc.). Additionally, output of the MLP model may be based on energy reflected and/or energy absorbed for each frequency band associated with a position in the audio environment corresponding to the inputted positional encoding.

The model generation engine 112 may utilize the audio data 106 and/or the video data 108 to generate an impulse response set associated with audio samples representing acoustic properties of the audio environment. Additionally, the model generation engine 112 may determine and/or correlate a location of a respective audio source and a respective audio receiver for a respective impulse response of the impulse response set. The impulse response set may be respective acoustic measurements between two audio sample locations in the audio environment. In some examples, an impulse response may be derived from a frequency response associated with an audio sample. In some examples, the model generation engine 112 may utilize the audio data 106 and/or the video data 108 to generate an image set. The image set may include a plurality of images each associated with the audio samples representing the acoustic properties of the audio environment. In some examples, information captured from the audio data 106 and/or the video data 108 may include: volume density, optical radiance, ambient audio volume density, reflected acoustic transfer functions, transmitted acoustic transfer functions, and/or other information.

In some examples, an impulse response of the impulse response set may estimate an impulse response across a location of an audio source and a frequency response may be cascaded based on the impulse response. In some examples, an impulse response may be estimated by evaluating volume room density functions between two locations in the audio environment. In some examples, a volume density function may utilize environmental measurements such as, but not limited to: temperature, humidity, air speed and direction, pressure, density, fluid flow direction and intensity, viscosity, shear, elasticity, and/or other environmental measurements at the locations. For instance, an impulse response may be adjusted based on the environmental measurements.

In some examples, an impulse response of the impulse response set may be calculated based on a digital transform (e.g., a Fourier transform) of an audio frequency response. An audio frequency response may be between any two locations in the audio environment and may be calculated from estimated acoustic transfer functions (e.g., estimated reflected and/or transmitted acoustic transfer functions) and/or characteristic impedance of air in the audio environment. In some examples, an audio frequency response may be represented by the following equation (1):

$$H ( f ) = \frac{{V}_{L}}{{V}_{S}} = \frac{{Z}_{L}}{{AZ}_{L} + B + {CZ}_{S} {Z}_{L} + {DZ}_{S}} \qquad ( 1 )$$

where Z represents a characteristic acoustic impedance of air. Variables A, B, C and D may be represented by the following equation (2):

$$[ \begin{matrix}A & B \\ C & D\end{matrix} ] = [ \begin{matrix}\frac{( 1 + {S}_{11} ) ( 1 - {S}_{22} ) + {S}_{12} {S}_{21}}{2 {S}_{21}} & Z \frac{( 1 + {S}_{11} ) ( 1 + {S}_{22} ) - {S}_{12} {S}_{21}}{2 {S}_{21}} \\ \frac{1}{Z} \frac{( 1 - {S}_{11} ) ( 1 - {S}_{22} ) - {S}_{12} {S}_{21}}{2 {S}_{21}} & \frac{( 1 - {S}_{11} ) ( 1 + {S}_{22} ) + {S}_{12} {S}_{21}}{2 {S}_{21}}\end{matrix} ] \qquad ( 2 )$$

where S11 corresponds to a reflected audio transfer function at point 1, S12 corresponds to a transmitted audio transfer function between point 1 and point 2, S22 corresponds to a reflected audio transfer function at point 2, and S21 corresponds to a transmitted audio transfer function between point 2 and point 3.

Based on the audio samples, the model generation engine 112 may determine a camera properties set comprising relative audio sample locations and camera orientations associated with the audio samples. The model generation engine 112 may then generate the audio rendering model 105 based on the impulse response set, the image set, the audio samples, and/or the camera properties set. The audio rendering model 105 may be a neural rendering volumetric representation of the audio environment augmented with audio encodings. For example, with the audio rendering model 105, different viewpoints within the audio environment may be augmented with audio encodings such that visual and acoustic attributes of the audio environment may be provided via the audio rendering model 105. In some examples, visual and acoustic attributes of the audio environment may be represented via neural radiance fields of the audio rendering model 105. As such, the audio rendering model 105 may be an implicit representation of physical and acoustic characteristics of the audio environment.

The audio rendering model 105 may map audio characteristics to specific colors or ranges of colors. The audio characteristics may include, but are not limited to: amplitude, frequency, latency, crest factor, wave speed, and/or another type of audio characteristic. In some examples, the audio rendering model 105 may map audio amplitudes to respective pixels of images in the image set. For example, an image may be converted from an RGB color format to a YUV format and audio amplitudes may be mapped to U components and/or V components of the YUV format. After being encoded with the audio, the images in the YUV format may be converted back to the RGB color format. It is to be appreciated that the audio rendering model 105 may alternatively map audio amplitudes to a different type of color space format.

In some examples, the neural acoustic modeling data 110 may include data representative of visual attributes and audio characteristics of the audio environment. For example, the neural acoustic modeling data 110 may include 3D model data associated with visual attributes of the audio environment. The 3D model data may include data related to 3D positions, viewing directions, color data, density data, camera pose data, and/or other visual attributes of the audio environment. In some examples, the 3D model data may be NeRF model data associated with one or more neural radiance fields of the audio environment. Additionally, the neural acoustic modeling data 110 may include audio data associated with the audio characteristics of the audio environment. For example, the audio data may include audio encodings (e.g., encoded audio characteristics) related to the audio environment. In some examples, the audio data may include one or more impulse responses associated with respective locations within the audio environment.

The neural acoustic modeling system 104 additionally or alternatively utilizes the model inference engine 113 to provide one or more inferences, predictions, and/or insights for an audio environment using the audio rendering model 105. For instance, one or more inferences, predictions, and/or insights related to the visual attributes and/or the acoustic attributes of the audio environment may be provided using the audio rendering model 105. The neural acoustic modeling inference data 111 may include the one or more inferences, predictions, and/or insights for the audio environment. In some examples, the neural acoustic modeling inference data 111 may include one or more impulse responses provided by the audio rendering model 105. In some examples, an impulse response included in the neural acoustic modeling inference data 111 may be a room impulse response (RIR) or an acoustic impulse response (AIR) that represents sound waves, reflections, reverberations, echoes, and/or other acoustic characteristics for the audio environment. The neural acoustic modeling inference data 111 may additionally or alternatively include one or more candidate audio component locations associated with the audio environment, one or more tuning settings for one or more audio devices in the audio environment, inferred acoustic properties of one or more surfaces in the audio environment, and/or one or more other inferences associated with the audio environment.

In some examples, the model inference engine 113 may output one or more candidate audio component locations associated with the audio environment. The one or more candidate audio component locations may be generated based on the audio rendering model 105. The one or more candidate audio component locations may respectively represent a candidate location within the audio environment for an audio component such as an audio capture device, an audio output device, or another type of audio component.

In some examples, inferences, predictions, and/or insights for an audio environment may enable simplified workflows (e.g., for accurate 3D acoustic modeling of audio environments or visual/acoustic modeling of audio environments). In some examples, inferences, predictions, and/or insights for an audio environment may enable optimized recommendations for placing audio devices and/or equipment within an audio environment.

In some examples, for a constellation of cameras, speakers, and/or microphone devices that are installed in a number of locations within an audio environment, the constellation of devices is enabled to automatically determine a 3D shape of an audio environment, where the devices are located in the audio environment, how the devices are oriented within the audio environment, and/or how the devices should be optimally configured. Accordingly, sounds within the audio environment may be output and/or captured at desirable levels and/quality for listeners and talkers within the audio environment.

In some examples, one or more impulse responses provided by the audio rendering model 105 may be utilized to improve placement of audio devices within an audio environment. An impulse response provided by the audio rendering model 105 may be a room impulse response (RIR) or an acoustic impulse response (AIR) that represents sound waves, reflections, reverberations, echoes, and/or other acoustic characteristics for a source-receiver location pair in an audio environment. The one or more impulse responses provided by the audio rendering model 105 may be utilized to accurately simulate acoustic characteristics of an audio environment to enable realistic sound reproduction and/or audio analysis for the audio environment. In some examples, one or more impulse responses provided by the audio rendering model 105 may be utilized to determine locations in the audio environment where an audio source and/or audio receiver are optimally positioned and/or oriented such that a sound source is captured in an optimal manner and/or reflections in the audio environment are minimized.

In some examples, inferences, predictions, and/or insights for an audio environment may enable generation of additional image data and/or audio data to model an audio environment for simulating and rendering audio (e.g., for scenarios where there are not enough devices in a constellation to capture a complete representation of the audio environment).

In some examples, the audio rendering model 105 may be utilized in an acoustic rendering process for the audio environment to render an impulse response for a source-receiver location pair in the audio environment. In some examples, a rendered impulse response may be an RIR or an AIR. A source-receiver location pair may be associated with a particular audio source and a particular capture device of the audio environment. In some examples, the audio rendering model 105 may enable a rendering process that utilizes a geometric representation of the audio environment to render the impulse responses (RIRs, AIRs, etc.) for source-receiver pairs. As such, the audio rendering model 105 may enable an acoustic simulation for one or more source-receiver location pairs within an audio environment. In some examples, a source-receiver location pair associated with a rendered impulse response may be a new source-receiver location pair that is not included in a training dataset for the audio rendering model 105. As such, the audio rendering model 105 may enable rendering of an impulse response from a previously unknown source-receiver location pair in the audio environment.

In some examples, one or more portions of the neural acoustic modeling inference data 111 may be output via an audio output device and/or a display output device. For example, one or more portions of the neural acoustic modeling inference data 111 may be output via an audio mixer device, a DSP processing device, a smartphone, a tablet computer, a laptop, a personal computer, an audio workstation device, a wearable device, an augmented reality device, a virtual reality device, a recording device, a microphone, headphones, earphones, speakers, a haptic device, or another type of output device. In some examples, one or more portions of the neural acoustic modeling inference data 111 may be rendered via a user interface (e.g., an electronic interface) of a user device as a smartphone, a tablet computer, a laptop, a personal computer, an audio workstation device, a touch controller device, an augmented reality device, a virtual reality device, or another type of user device.

In some examples, the acoustic simulation may be utilized to support one or more downstream systems such as, but not limited to, a system for determining placement of audio devices in an audio environment, a system for tuning audio devices in an audio environment, a system for designing and/or installing an audio system in an audio environment, a system for designing an architectural structure for an audio environment, a virtual reality system, and/or one or more other downstream systems with respect to the neural acoustic modeling system 104.

In some examples, inferences, predictions, and/or insights for an audio environment may enhance augmented reality, virtual reality, metaverse applications, and/or video game applications to model 3D environments and render realistic 3D audio for immersive participants in 3D spaces such that a listener wearing an augmented reality or virtual reality device in the simulated space will hear sounds in the simulated space with acoustic realism. For example, the audio rendering model 105 may be utilized to render audio in a simulated manner to represent how sound would propagate from an audio source location to an audio receiver in an audio environment. In some examples, an impulse response (RIR, AIR, etc.) provided by the audio rendering model 105 may be utilized to apply an audio effect to an audio signal to simulate how the audio would sound if transmitted between an audio source location and an audio receiver in an audio environment. In some examples, the simulated audio may be uniquely simulated as binaural audio for different ears of a listener at an audio receiver location. As such, the audio rendering model 105 may be utilized to enable an immersive audio experience for an audio environment associated with augmented reality, virtual reality, metaverse applications, and/or video game applications.

In some examples, inferences, predictions, and/or insights for an audio environment may be encapsulated and/or encoded via an interchangeable format such as a universal scene description (USD) format (e.g., OpenUSD) or another type of interchangeable format to translate environment information (e.g., 3D geometries, colors, material information, etc.) into a particular technological application (e.g., augmented reality, virtual reality, metaverse, etc.) for immersive collaboration, gaming, etc.

In some examples, one or more impulse responses provided by the audio rendering model 105 may be utilized to configure and/or tune one or more audio settings for one or more audio devices located within an audio environment. For example, one or more impulse responses provided by the audio rendering model 105 may be utilized to configure and/or tune a receiver device (e.g., a microphone, etc.) located within an audio environment. Additionally or alternatively, one or more impulse responses provided by the audio rendering model 105 may be utilized to configure and/or tune a sound source device (e.g., a speaker, etc.) located within an audio environment. In some examples, one or more impulse responses provided by the audio rendering model 105 may be utilized to configure and/or tune digital signal processing of audio captured by an audio device.

In some examples, directional sensitivity of an audio device may be adjusted based on one or more impulse responses provided by the audio rendering model 105 to optimally capture an audio source directly while minimizing undesirable sounds such as reflections, echoes, etc. Additionally or alternatively, equalization of an audio device may be adjusted based on one or more impulse responses provided by the audio rendering model 105 to accentuate or attenuate one or more audio frequencies captured by the audio device to accommodate for impact of particular audio characteristics of the audio environment. Equalization of a sound source device may be additionally or alternatively adjusted based on one or more impulse responses provided by the audio rendering model 105 to modify a frequency response associated with the audio environment. Additionally or alternatively, reverberation of an audio device may be adjusted based on one or more impulse responses provided by the audio rendering model 105 to provide improved dereverberation and/or reduce impact of audio reflections in the audio environment.

In some examples, one or more impulse responses provided by the audio rendering model 105 may be utilized for room or building design associated with an audio environment. For example, a room acoustics software application may utilize one or more impulse responses provided by the audio rendering model 105 to provide room acoustics simulations and/or measurements to enable construction and/or configuration of a room or building associated with an audio environment. As such, areas of interest in a room or building may be identified and/or the impulse responses may be utilized to inform construction or treatment of the room or building. In some examples, placement of acoustic panels and/or recommended materials in a room or building may be determined based on one or more impulse responses provided by the audio rendering model 105.

In some examples, one or more impulse responses provided by the audio rendering model 105 may be utilized to infer acoustic properties of one or more surfaces within an audio environment. Additionally or alternatively, based on the inferred acoustic properties of one or more surfaces within the audio environment, a material type of the one or more surfaces may be inferred. The material type may include a particular material such as, but not limited to, plaster, wood, metal, etc. In some examples, the inferred acoustic properties of one or more surfaces within the audio environment may be utilized to query a lookup table or database associated with mappings between acoustic properties and material types. In some examples, the lookup table or database may be associated with mappings between audio absorption characteristics (e.g., absorption coefficients, etc.) and material types. As such, rather than a particular material type being preassigned (e.g., by a user) to surfaces or objects within a model of an environment, the one or more impulse responses provided by the audio rendering model 105 may be utilized to infer a material type for one or more surfaces or objects within an audio environment.

In some examples, inferences, predictions, and/or insights for an audio environment may additionally or alternatively enhance: architectural modeling of rooms and effects of changed surface, data set generation for room types and as input for other model training, training of a model to enhance dereverberation in specific rooms and geometries, modeling of directional sound sources (e.g., speakers) and/or sensors, collection of data to train neural representations, and/or one or more other technical improvements related to audio processing.

In some examples, the model inference engine 113 receives the digital exploration request 109. The digital exploration request 109 may be a request to digitally explore visual attributes and/or audio attributes of an audio environment. The digital exploration request 109 may also include an audio environment identifier for the audio environment. The audio environment identifier may be a digital code, a bit string, an alphanumeric string, or another type of identifier that identifies the audio environment. For example, the audio environment may be known as “Meeting Room A” and the audio environment identifier may be a digital code, a bit string, an alphanumeric string, or another type of identifier that corresponds to the phrase “Meeting Room A.” In some examples, the digital exploration request 109 may additionally or alternatively include information related to a number of audio devices, candidate audio device locations, camera locations, camera angles, an X, Y, Z location, pitch information, roll information, yaw information, an image related to a viewpoint, spherical coordinate information, azimuth information, elevation information, and/or other information related to an audio environment to facilitate digital exploration of visual attributes and/or audio attributes of the audio environment.

In some examples, the digital exploration request 109 is received from a user device such as a smartphone, a tablet computer, a laptop, a personal computer, an audio workstation device, a touch controller device, an augmented reality device, a virtual reality device, or another type of user device. In some examples, the digital exploration request 109 is generated via a user interface of a display of the user device. The user interface may be a graphical user interface for a design application, an installation application, an audio device configuration application, an audio processing application, a system configuration application, or another type of application related to a software platform.

Based on the audio environment identifier, the model inference engine 113 may determine an audio rendering model (e.g., the audio rendering model 105) associated with the audio environment. For example, the model inference engine 113 may correlate the audio environment identifier with an audio rendering model (e.g., the audio rendering model 105) associated with the audio environment. In some examples, the audio rendering model is selected from a set of audio rendering models where respective audio rendering models of the set of audio rendering models are previously generated for a particular audio environment.

Accordingly, the neural acoustic modeling system 104 may provide improved modeling and/or inferences with respect to an audio environment as compared to traditional modeling techniques. Additionally, accuracy of localization of a sound source in an audio environment may be improved by employing the neural acoustic modeling system 104. The neural acoustic modeling system 104 may additionally or alternatively be adapted to produce improved audio signals with reduced noise, reverberation, and/or other undesirable audio artifacts even in view of exacting audio latency requirements. For example, the neural acoustic modeling system 104 may optimize configuration and/or location of audio capture devices in an audio environment to produce improved audio signals with reduced noise, reverberation, and/or other undesirable audio artifacts. As such, audio may be provided to a user without the undesirable sound reflections. The neural acoustic modeling system 104 may also improve runtime efficiency of denoising, dereverberation, and/or other audio filtering while also optimizing acoustic performance of an audio system.

The neural acoustic modeling system 104 may also employ fewer computing resources when compared to traditional audio processing systems. Additionally or alternatively, in one or more examples, the neural acoustic modeling system 104 may be configured to deploy a smaller number of memory resources allocated to denoising, dereverberation, and/or other audio processing for an audio signal. In still other examples, the neural acoustic modeling system 104 may be configured to improve processing speed of modeling operations, denoising operations, dereverberation operations, and/or audio processing operations. These improvements may enable improved audio processing systems and/or hardware/software configurations in an audio environment where high-fidelity audio is desirable and/or where processing efficiency is important.

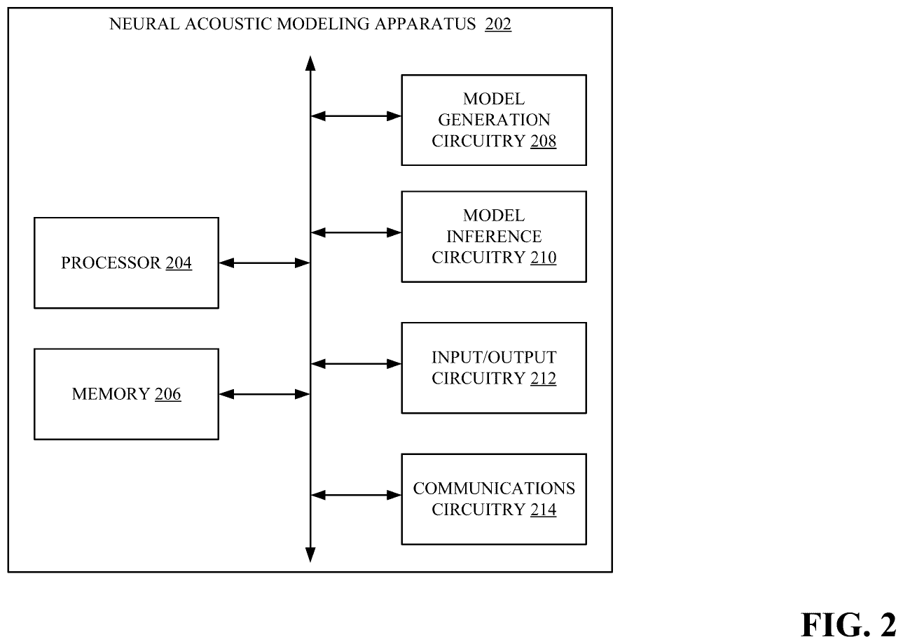

FIG. 2 illustrates an example neural acoustic modeling apparatus 202 configured in accordance with one or more embodiments of the present disclosure. The neural acoustic modeling apparatus 202 may be configured to perform one or more techniques described in FIG. 1 and/or one or more other techniques described herein.

The neural acoustic modeling apparatus 202 may be a computing system communicatively coupled with one or more circuit modules related to audio processing. The neural acoustic modeling apparatus 202 may comprise or otherwise be in communication with a processor 204, a memory 206, model generation circuitry 208, model inference circuitry 210, input/output circuitry 212, and/or communications circuitry 214. In some examples, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise audio data, stereo audio signal data, mono audio signal data, radio frequency signal data, video data, imagery data, training data for an audio rendering model, a set of weights for an audio rendering model, a set of trained audio rendering models, or the like, for enabling the neural acoustic modeling apparatus 202 to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, a field programmable gate array (FPGA), a neural processing unit (NPU), a graphics processing unit (GPU), a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 204 may comprise one or more processing cores configured to perform independently. A multi-core processor may enable multiprocessing within a single physical package. Additionally or alternatively, the processor 204 may comprise one or more processors configured in tandem via a bus to enable independent execution of instructions, pipelining, and/or multithreading.

In some examples, the processor 204 may be configured to execute instructions, such as computer program code or instructions, stored in the memory 206 or otherwise accessible to the processor 204. Alternatively or additionally, the processor 204 may be configured to execute hard-coded functionality. As such, whether configured by hardware or software instructions, or by a combination thereof, the processor 204 may represent a computing entity (e.g., physically embodied in circuitry) configured to perform operations according to an embodiment of the present disclosure described herein. For example, when the processor 204 is embodied as an CPU, DSP, ARM, FPGA, ASIC, or similar, the processor may be configured as hardware for conducting the operations of an embodiment of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an embodiment of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In one or more examples, the neural acoustic modeling apparatus 202 may comprise the model generation circuitry 208. The model generation circuitry 208 may be any means embodied in either hardware or a combination of hardware and software that is configured to perform one or more functions disclosed herein related to the model generation engine 112. In one or more examples, the neural acoustic modeling apparatus 202 may comprise the model inference circuitry 210. The model inference circuitry 210 may be any means embodied in either hardware or a combination of hardware and software that is configured to perform one or more functions disclosed herein related to the model inference engine 113.

In some examples, the neural acoustic modeling apparatus 202 may comprise the input/output circuitry 212 that may, in turn, be in communication with processor 204 to provide output to the user and, in some examples, to receive an indication of a user input. The input/output circuitry 212 may comprise a user interface and may comprise a display. In some examples, the input/output circuitry 212 may also comprise a keyboard, a touch screen, touch areas, soft keys, buttons, knobs, or other input/output mechanisms.

In some examples, the neural acoustic modeling apparatus 202 may comprise the communications circuitry 214. The communications circuitry 214 may be any means embodied in either hardware or a combination of hardware and software that is configured to receive and/or transmit data from/to a network and/or any other device or module in communication with the neural acoustic modeling apparatus 202. In this regard, the communications circuitry 214 may comprise, for example, an antenna or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. Additionally or alternatively, the communications circuitry 214 may comprise the circuitry for interacting with the antenna/antennae to cause transmission of signals via the antenna/antennae or to handle receipt of signals received via the antenna/antennae.

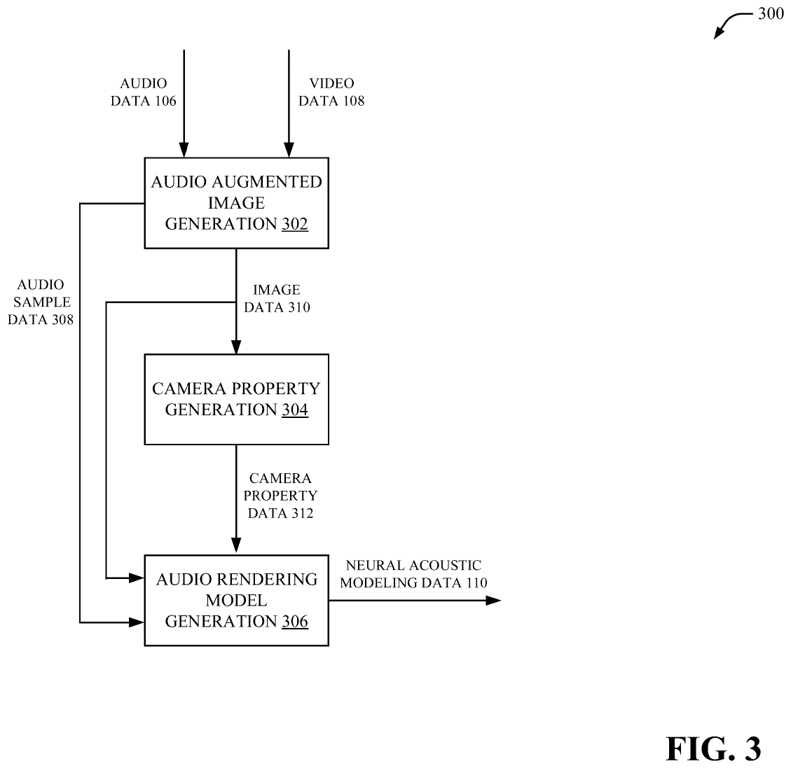

FIG. 3 illustrates a neural rendering model generation flow 300 for neural rendering model generation enabled by the model generation engine 112 of FIG. 1 according to one or more embodiments of the present disclosure. The neural rendering model generation flow 300 includes audio augmented image generation 302, camera property generation 304, and audio rendering model generation 306.

The audio augmented image generation 302 utilizes the audio data 106 and/or the video data 108 to generate audio sample data 308. The audio sample data 308 may include an impulse response set for each source-listener audio device pair within the audio environment. The audio augmented image generation 302 additionally or alternatively utilizes the video data 108 to generate image data 310. Based on the image data 310, the camera property generation 304 generates camera property data 312. In some examples, the camera property generation 304 may infer position of the one or more capture devices 102. In some examples, the position of the one or more capture devices 102 may correspond to a camera location provided by a photogrammetry process associated with the camera property generation 304. Additionally, based on the audio sample data 308, the image data 310, and/or the camera property data 312, the audio rendering model generation 306 may generate the neural acoustic modeling data 110. In some examples, the camera property data 312 includes sensor information related to a location and/or an orientation of the one or more capture devices 102 and/or one or more audio sources.

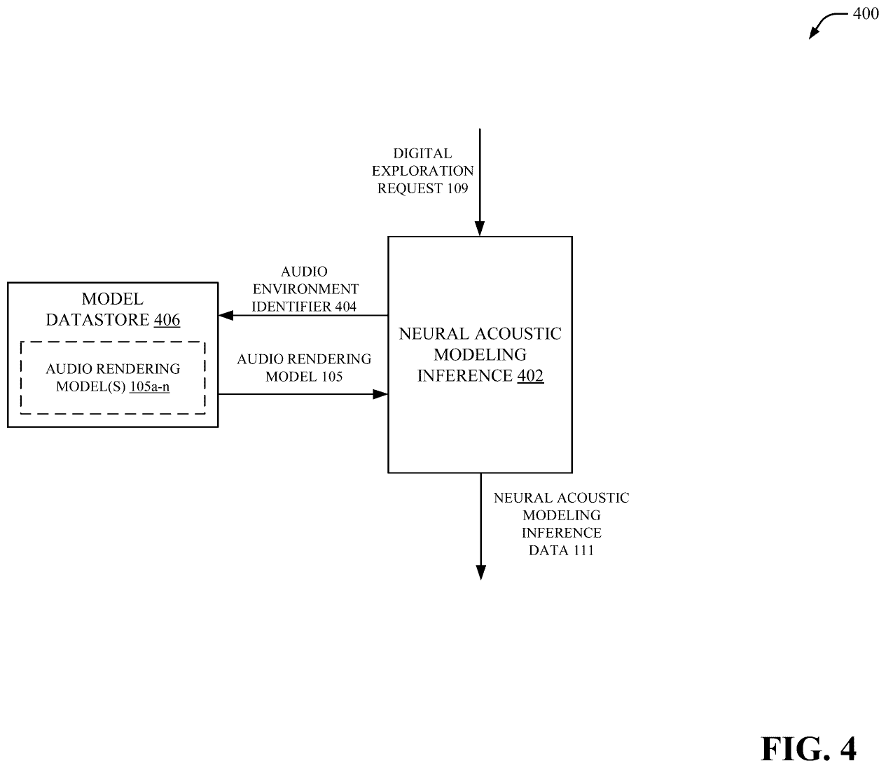

FIG. 4 illustrates a neural rendering model inference flow 400 for neural rendering model inferences enabled by the model inference engine 113 of FIG. 1 according to one or more embodiments of the present disclosure. The neural rendering model inference flow 400 includes neural acoustic modeling inference 402.

The neural acoustic modeling inference 402 utilizes the digital exploration request 109 to generate the neural acoustic modeling inference data 111. In some examples, the neural acoustic modeling inference 402 determines an audio environment identifier 404 included in the digital exploration request 109. Based on the audio environment identifier 404, the neural acoustic modeling inference 402 may query a model datastore 406 that includes a set of audio rendering models 105a-n. The model datastore 406 may be integrated in or communicatively coupled to a cloud platform (e.g., a server system) or a user device such as a smartphone, a tablet computer, a laptop, a personal computer, an audio workstation device, a touch controller device, an augmented reality device, a virtual reality device, or another type of user. In some examples, respective audio rendering models of the set of audio rendering models 105a-n are trained via the cloud platform. In some examples, respective audio rendering models of the set of audio rendering models 105a-n are trained via the user device. Accordingly, training of the respective audio rendering models of the set of audio rendering models 105a-n may be performed at a same device or a different device with respect to storage of the respective audio rendering models of the set of audio rendering models 105a-n via the model datastore 406.

In some examples, the neural acoustic modeling inference 402 may correlate the audio environment identifier 404 to the audio rendering model 105 from the set of audio rendering models 105a-n. The audio rendering model 105 may be utilized by the neural acoustic modeling inference 402 to generate the neural acoustic modeling inference data 111. In some examples, the neural acoustic modeling inference data 111 includes one or more audio inferences associated with the audio environment. In some examples, the neural acoustic modeling inference data 111 may include inferred values related to volume density, radiance, ambient audio volume density, reflected acoustic transfer functions, transmitted acoustic transfer functions, other inferred acoustic information, inferred material properties for structures or objects within the audio environment, and/or other information. In some examples, the inferred material properties may include inferred absorption characteristics (e.g., inferred absorption coefficients, etc.) for respective material types associated with structures or objects within the audio environment. In some examples, a response or sensitivity of the user device and/or audio equipment such as a microphone or speaker may be modified in real-time based on the neural acoustic modeling inference data 111 and/or a determined location within the audio environment that corresponds to the latent encoding contained within the audio rendering model 105.

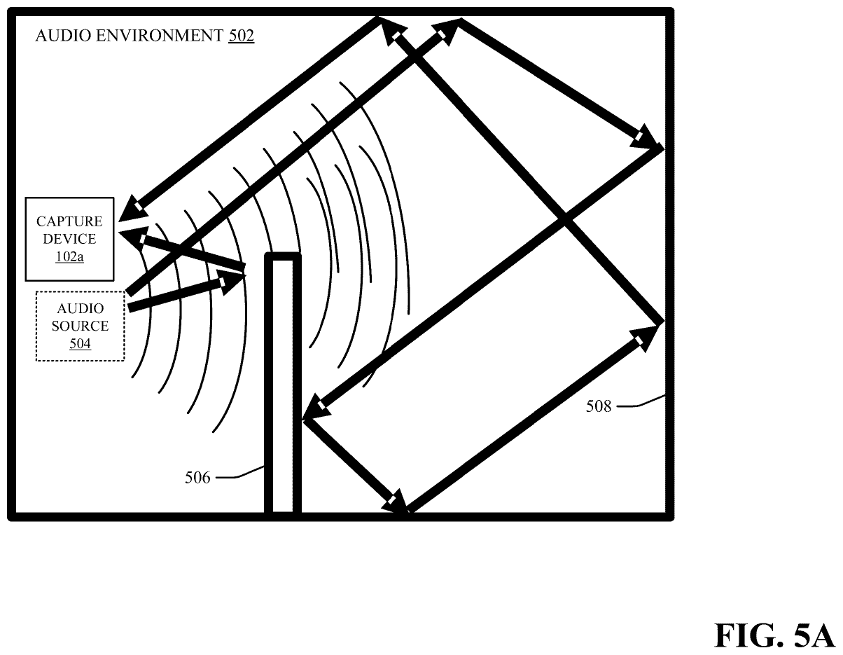

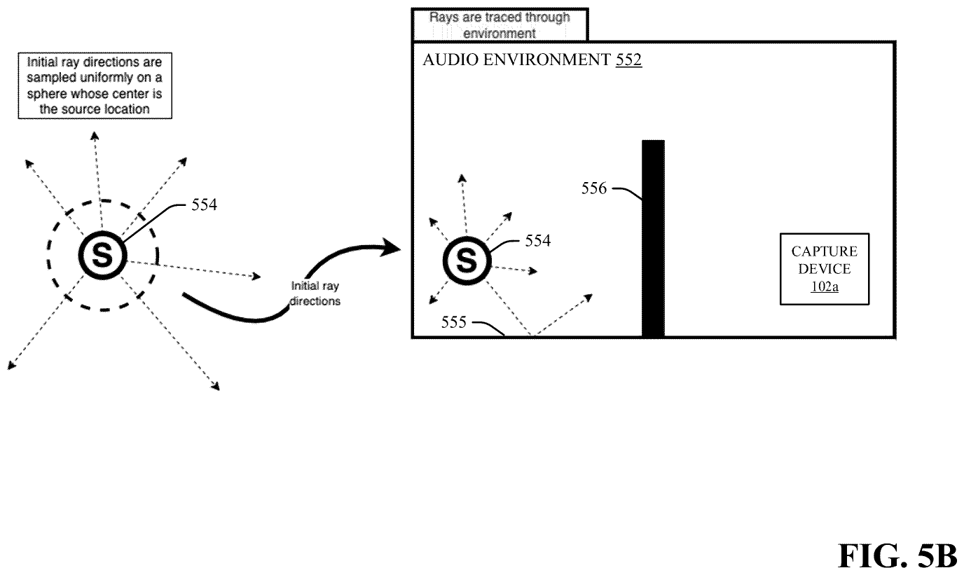

FIG. 5A illustrates an example audio environment 502 according to one or more embodiments of the present disclosure. The audio environment 502 may be an indoor environment, an outdoor environment, a room, a conference room, a meeting room, an auditorium, a performance hall, a broadcasting environment, an arena (e.g., a sports arena), a virtual environment, or another type of audio environment. The audio environment 502 includes a capture device 102a that is capable of capturing audio from an audio source 504. In some examples, the capture device 102a is configured as an audio capture device such as, for example, a microphone or microphone array. In some examples, the capture device 102a is configured as a video capture device that is capable of capturing video data in addition to audio data.

In some examples, audio is reflected throughout the audio environment 502 to facilitate neural rendering model generation. For example, the audio source 504 may emit audio (e.g., a broad-spectrum chirp, a sine sweep, etc.) and the capture device 102a may be a directional microphone located proximate to the audio source 504 to capture reflected audio. The audio emitted by the audio source 504 may include a frequency range that corresponds to a desired frequency range for the neural acoustic modeling inference data 111. For example, if it is desirable to optimize an audio environment for human speech, then the audio emitted by the audio source 504 may include a frequency range that corresponds 300 Hz to 3 kHz associated with human speech. In some examples, the audio may be reflected off a near wall 506 and a far wall 508 of the audio environment prior to being captured by the capture device 102a. However, it is to be appreciated that audio emitted in the audio environment 502 may be transmitted, reflected, refracted, diffracted, absorbed, and/or scattered in the audio environment prior to being captured by the capture device 102a. Modeling with respect to audio emitted in the audio environment 502 may be related to reflections, transmission, refraction, diffraction, doppler effect, resonance, and/or one or more other acoustic phenomena.

FIG. 5B illustrates an example audio environment 552 according to one or more embodiments of the present disclosure. The audio environment 552 may be an indoor environment, an outdoor environment, a room, a conference room, a meeting room, an auditorium, a performance hall, a broadcasting environment, an arena (e.g., a sports arena), a virtual environment, or another type of audio environment. The audio environment 552 includes a capture device 102a that is capable of capturing audio from an audio source 554. In some examples, the capture device 102a is configured as an audio capture device such as, for example, a microphone or microphone array. In some examples, the capture device 102a is configured as a video capture device that is capable of capturing video data in addition to audio data.

In some examples, audio is reflected throughout the audio environment 552 to facilitate ray-traced neural acoustic modeling. In some examples, ray direction sampling from the audio source 554 may be provided to facilitate the ray-traced neural acoustic modeling. The audio source 554 may emit audio rays from a source location. The audio rays may be a broad-spectrum chirp, a sine sweep, or another type of audio. In some examples, the capture device 102a may sample the audio rays uniformly on a sphere with a center at the source location associated with the audio source 554. Additionally, the audio rays may be traced through the audio environment 552 where respective energies of the audio rays are attenuated when reflecting off surfaces such as, for example, surface 555 or surface 556. In some examples, the model generation engine 112 may generate an energy histogram associated with the audio rays captured by the capture device 102a to facilitate a rendering process for the audio environment 502.

In some examples, energy of the sampled audio rays may be attenuated based on directionality of the audio source 554. For example, if an audio ray is sampled in a direction against directionality of the audio source 554, a calculated energy for the audio ray may be reduced. Alternatively, directionality of the audio source 554 may be modeled by sampling audio rays along a direction of the audio source 554. In some examples, directionality of the capture device 102a (e.g., directionality of a receiver of the capture device 102a) may be similarly modeled such that energy of intersecting audio rays is reduced based on a direction of the audio rays in relation to a direction of a pickup pattern for capturing audio related to the audio source 504.

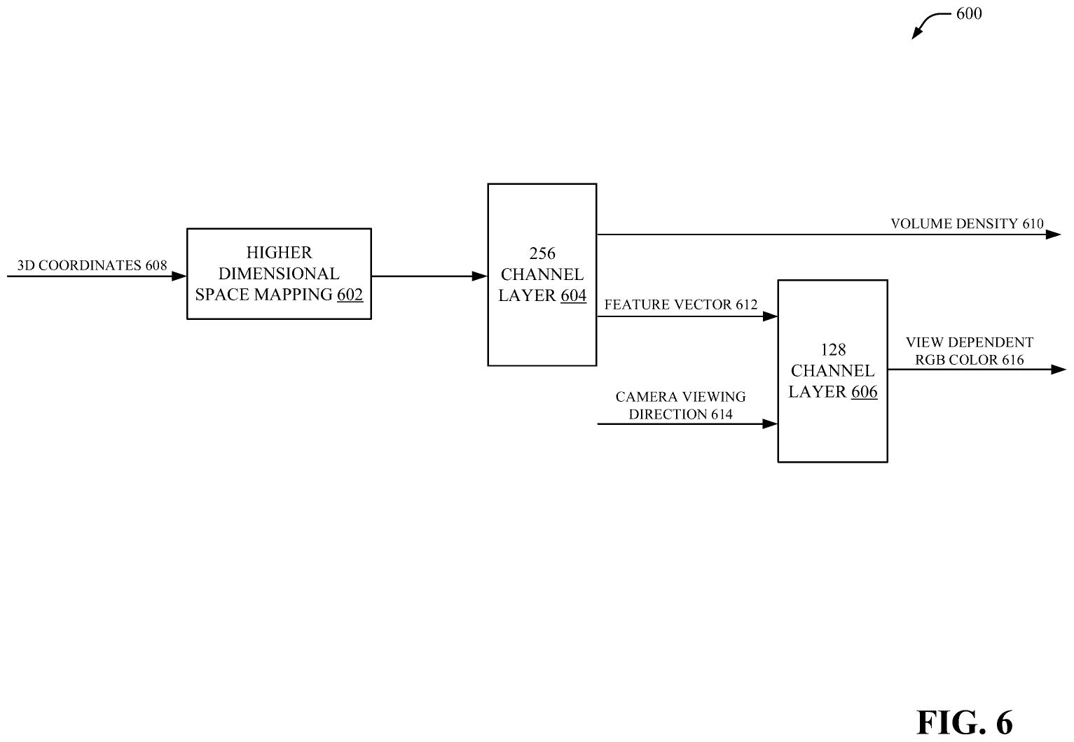

FIG. 6 illustrates a model 600 according to one or more embodiments of the present disclosure. In some examples, the audio rendering model is a machine learning model, an audio rendering model, an augmented neural rendering model, an augmented NeRF model, or another type of model. The model 600 may receive 3D coordinates 608 and a camera viewing direction 614 as input. The 3D coordinates 608 may include x-coordinates, y-coordinates, and z-coordinates for respective spatial locations in an audio environment. The camera viewing direction 614 may include respective viewing directions for respective images captured in the audio environment. In some examples, the 3D coordinates 608 and the camera viewing direction 614 may be provided to a stack of fully connected, linear layers separated by nonlinear activation functions. However, it is to be appreciated that the model 600 may additionally or alternatively include one or more other types of layers and/or functionality. Based on processing of the 3D coordinates 608 and the camera viewing direction 614 via the fully connected, linear layers and the nonlinear activation functions, the model 600 may output a volume density 610 and a view dependent RGB color 616. The volume density 610 may indicate an amount of radiance and/or luminance associated with the respective 3D coordinates 608. The view dependent RGB color 616 may be indicative of RGB color information associated with the respective 3D coordinates 608. In some examples, the model 600 may be an MLP model.

In some examples, the model 600 includes higher dimensional space mapping 602, a layer 604, and a layer 606. The layer 604 may be a 256-channel layer and the layer 606 may be a 128-channel layer. However, it is to be appreciated that, in some examples, the layer 604 and/or the layer 606 may include a different number of channels. Additionally, the layer 604 and/or the layer 606 may respectively be a neural network layer, a fully-connected layer, a convolutional layer, and/or another type of layer that models a volumetric representation of the audio environment. The higher dimensional space mapping 602 may utilize positional encoding to map the 3D coordinates 608 into a higher dimensional space for processing by the layer 604. The 3D coordinates 608 may represent an x-coordinate, a y-coordinate, and a z-coordinate location within an audio environment. The layer 604 may utilize the 3D coordinates 608 with the higher dimensionality to generate the volume density 610 and a feature vector 612. The volume density 610 may represent differential probability of a ray terminating at the 3D coordinates 608. The feature vector 612 may include: encoding parameters, spatial coordinates, color information, radiance information, reflectance information, viewpoint information, density information, and/or other information related to respective 3D coordinates in the audio environment. The feature vector 612 may be a 256-dimensional feature vector or a feature vector with different dimensionality. The layer 606 may utilize the feature vector 612 and the camera viewing direction 614 to generate the view dependent RGB color 616. In some examples, the volume density 610 and/or the view dependent RGB color 616 may be augmented with audio encodings related to audio data (e.g., audio data 106) captured in the audio environment.

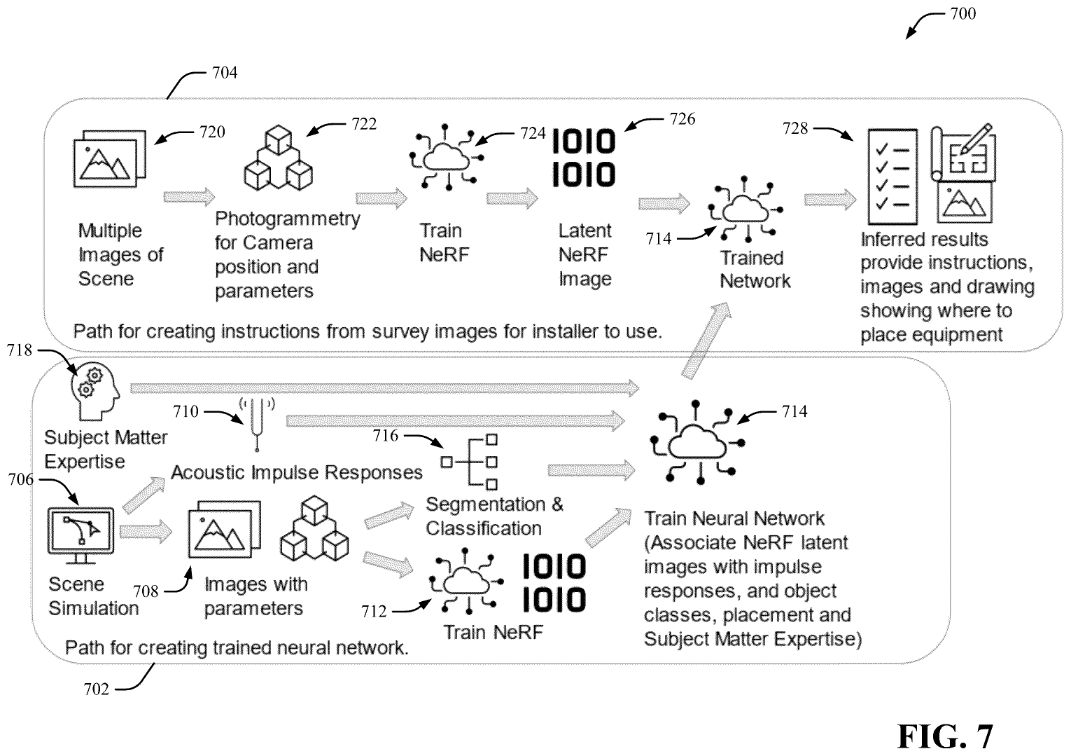

FIG. 7 illustrates a neural rendering flow 700 for neural rendering enabled by the neural acoustic modeling system 104 of FIG. 1 according to one or more embodiments of the present disclosure. The neural rendering flow 700 includes a path 702 for creating a trained neural network and a path 704 for creating instructions from survey images for an installer of an audio system to use for an audio environment.

With the path 702, a simulation 706 of an audio environment results in images 708 with parameters. The simulation 706 also results in acoustic impulse responses 710. The images 708 may be employed for training 712 of an audio rendering model 714. In some examples, the images 708 may undergo segmentation and/or classification 716 to facilitate the training 712 of the audio rendering model 714. In certain examples, a subject matter expert 718 may facilitate supervised learning with respect to the images 708. A trained version of the audio rendering model 714 may associated NeRF latent images with impulse responses, object classes, object placement, and/or object labels.

With the path 704, images 720 of an audio environment may undergo photogrammetry 722 to determine camera positions and/or camera parameters associated with the images 720. In some examples, the photogrammetry 722 may be utilized to estimate a relative 3D location (e.g., x, y, z coordinates) and orientation (e.g., pitch, yaw and roll) of the images 720. The images 720 along with the location and orientation data may then be utilized via training 724 to train weights of the audio rendering model 714 related to volumetric probability densities which represent a respective location of structures within an audio environment. In some examples, the camera positions and/or camera parameters may be utilized to for the training 724 of the audio rendering model 714 with latent NeRF images 726. The latent NeRF images 726 may correspond to weights (e.g., weights for the audio rendering model 714) representing an intrinsic encoding of volumetric density of an audio environment. In some examples, the trained version of the audio rendering model 714 may be utilized to provide one or more inferences 728 associated with the audio environment.

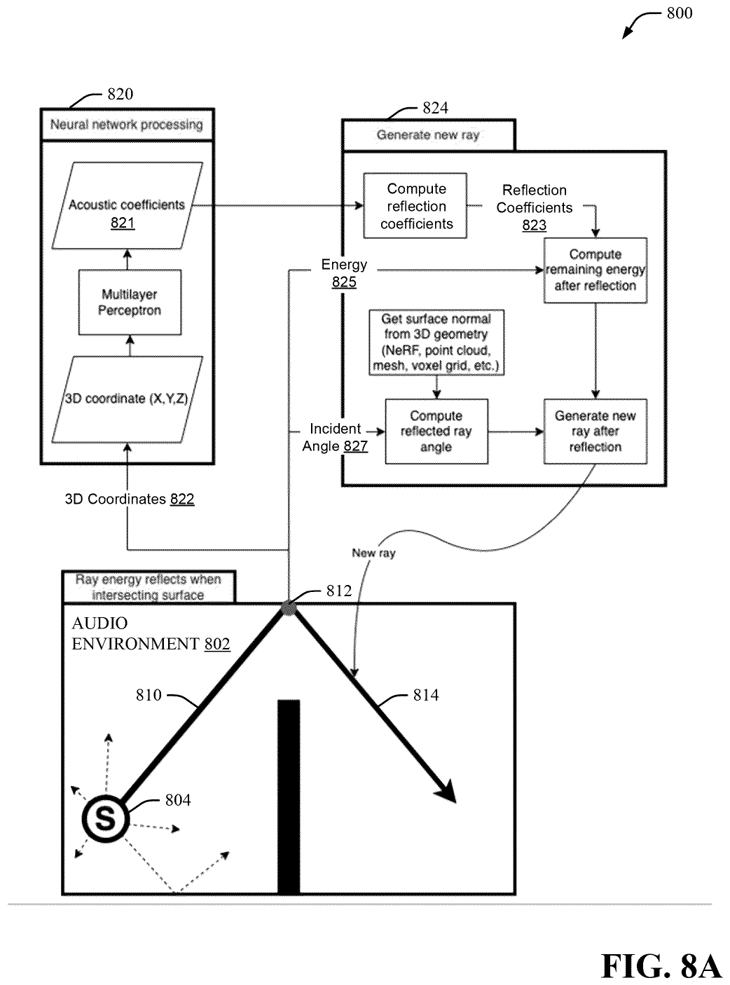

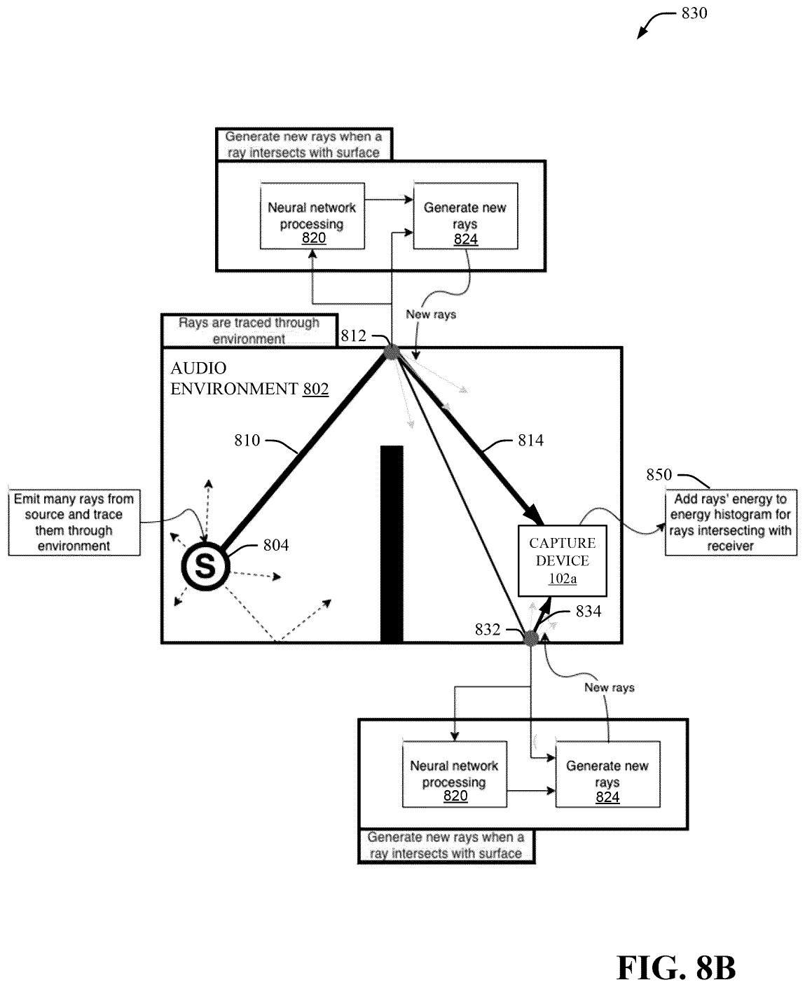

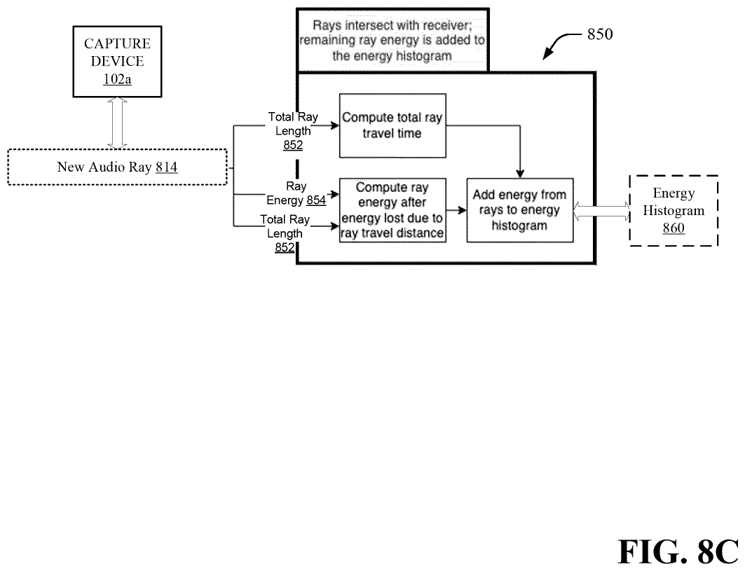

FIG. 8A illustrates a neural rendering flow 800 for ray-traced neural acoustic modeling enabled by the neural acoustic modeling system 104 of FIG. 1 according to one or more embodiments of the present disclosure. The neural rendering flow 800 may utilize specular reflection to provide the ray-traced neural acoustic modeling. Audio rays generated by an audio source 804 may be reflected off surfaces while being traced through an audio environment 802. When an audio ray 810 intersects a surface 812 via specular reflection, a new audio ray 814 may be generated with a reflection angle equal to an incident angle of the audio ray 810. Additionally, an energy of the new audio ray 814 may be based on the audio ray 810 attenuated by acoustic coefficients 821 of the surface 812 at a location of impact on the surface 812. In some examples, when the audio ray 810 intersects the surface 812 via diffuse reflection (e.g., scattering), the new audio ray 814 may be a plurality of new audio rays. For example, a sampling distribution for the plurality of new audio rays may be sampled from a hemisphere shape or a cone shape along an angle of reflection for the audio ray 810.

In some examples, the acoustic coefficients 821 may be predicted by neural network processing 820 provided by the model generation engine 112. For example, the neural network processing 820 may utilize one or more MLP techniques to predict the acoustic coefficients 821. In some examples, the neural network processing 820 receives 3D coordinates 822 as input. The 3D coordinates 822 may correspond to the location of impact of the audio ray 810 on the surface 812. In some examples, specular reflection coefficients 823 may be computed based on the acoustic coefficients 821 via new ray generation 824 provided by the model generation engine 112. The specular reflection coefficients 823 may be specular reflection coefficients for specular reflection scenarios related to the audio ray 810. Alternatively, the specular reflection coefficients 823 may be diffuse reflection coefficients for diffuse reflection scenarios related to the audio ray 810. In some examples, based on the specular reflection coefficients 823 and an energy 825 of the audio ray 810 at the location of impact on the surface 812, a remaining energy after reflection may be predicted to generate the new ray 814. In some examples, the remaining energy after reflection may additionally be predicted based on an incident angle 827 of the audio ray 810. For example, a reflected ray angle for the new ray 814 may be predicted based on the incident angle 827 and surface information for the surface 812. The surface information may be determined based on a 3D geometry of the audio environment 802. For example, a 3D model (e.g., NeRF, point cloud, mesh, voxel grid, etc.) of the audio environment 802 may be queried to determine surface information such as a surface normal of the surface 812.

FIG. 8B illustrates a neural rendering flow 830 for ray-traced neural acoustic modeling enabled by the neural acoustic modeling system 104 of FIG. 1 according to one or more embodiments of the present disclosure. The neural rendering flow 830 may generate an impulse response set related to audio rays in the audio environment 802. For example, a capture device 102a may capture the new audio ray 814. Additionally, the model generation engine 112 may determine energy associated with the new audio ray 814 and add the energy associated with the new audio ray 814 to an energy histogram for the audio environment 802 via a neural rendering flow 850. The model generation engine 112 may also convert the energy histogram into an impulse response set related to the audio environment 802. In some examples, the energy histogram may include energy related to one or more other audio rays such as, for example, audio ray 834 reflect off surface 832 of the audio environment 802. In some examples, the audio ray 834 may also undergo processing by the neural network processing 820 and/or the new ray generation 824. In some examples, the audio ray 834 may be a result of diffuse reflections associated with the audio ray 810.

FIG. 8C illustrates the neural rendering flow 850 for ray-traced neural acoustic modeling enabled by the neural acoustic modeling system 104 of FIG. 1 according to one or more embodiments of the present disclosure. The neural rendering flow 850 may be related to a ray-receiver intersection between the new audio ray 814 and the capture device 102a. For example, the new audio ray 814 may intersect with the capture device 102a and a remaining ray energy 854 may be added to an energy histogram 860 for the audio environment 802. In some examples, a value of the ray energy 854 may be modified based on a total ray length 852 of the new audio ray 814 to provide a ray energy after energy lost due to ray travel distance to the energy histogram 860. In some examples, a value of the ray energy 854 may be additionally modified based on a direction of arrival associated with the new audio ray 814 with respect to the capture device 102a. In some examples, the total ray length 852 may additionally or alternatively be utilized to compute a total ray travel time for the new audio ray 814. In some examples, the total ray travel time for the new audio ray 814 may provide a time-delay for the new audio ray 814 and the time-delay may additionally be recorded in the energy histogram 860. In some examples, the energy histogram 860 may be a 2D histogram with bins configured over ranges of time delays and/or frequencies. In some examples, environmental conditions for an audio environment (e.g., temperature, humidity, etc.) may affect travel time for the new audio ray 814 due to the effect of the speed of sound. As such, the remaining ray energy 854 may be added to the energy histogram 860 based on environmental conditions and/or related speeds of sound. In some examples, the time-delay for the new audio ray 814 may be determined based on the environmental conditions. In some examples, the energy histogram 860 may be converted into a set of impulse responses for the audio environment 802. In some examples, the set of impulse responses may be synthesized via a Poisson-distributed noise process.

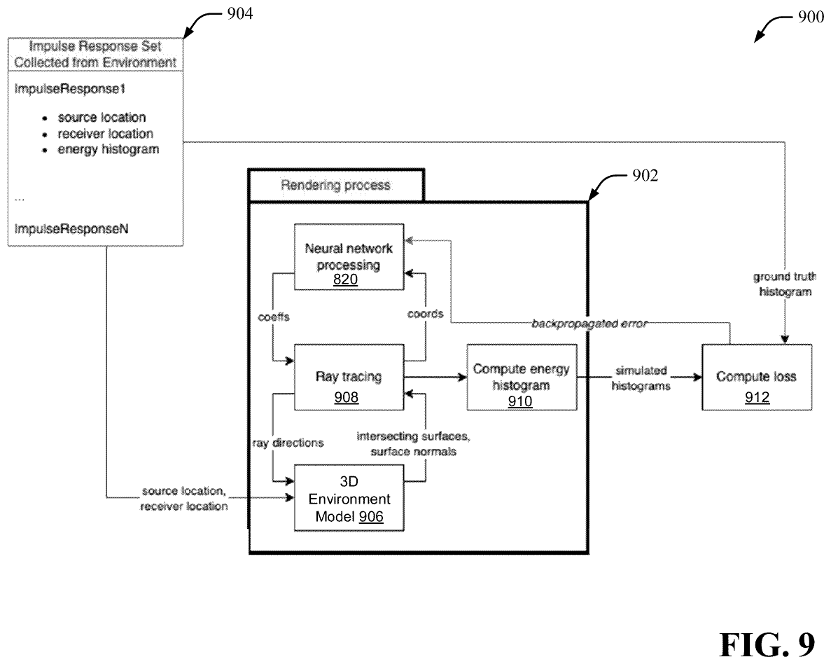

FIG. 9 illustrates training flow 900 enabled by the neural acoustic modeling system 104 of FIG. 1 according to one or more embodiments of the present disclosure. The training flow 900 includes a rendering process 902. The rendering process 902 may predict an energy histogram based on source and receiver locations. In some examples, source and receiver locations are determined based on an impulse response set 904 related to an audio environment. In some examples, the rendering process 902 utilizes a 3D environment model 906. The 3D environment model 906 may be a NeRF model, a point cloud model, a mesh model, a voxel grid model, or another type of 3D environment model of an audio environment. The 3D environment model 906 may be utilized to provide surface information such as surface normals and/or intersecting surfaces in the audio environment. The 3D environment model 906 may additionally or alternatively be utilized to compute a total ray travel distance. In some examples, 3D environment model 906 may additionally or alternatively be utilized to compute time-delay of an audio source to an audio capture device based on environmental conditions related to the audio environment.

The rendering process 902 additionally or alternatively utilizes ray tracing 908. The ray tracing 908 may provide 3D coordinates related to surfaces reflections for audio rays within the audio environment. The rendering process 902 additionally or alternatively utilizes the neural network processing 820 to provide reflection coefficients related to the 3D coordinates. Based on the ray tracing 908, the training flow 900 includes an energy histogram process 910 for generating an energy histogram related to the audio environment. In some examples, in addition or alternatively to the ray tracing 908, the rendering process 902 may utilize one or more other acoustic simulation techniques such as, but not limited to: an image-source acoustic simulation technique, a wave-based acoustic simulation technique, a diffuse rain acoustic simulation technique (e.g., for modeling energy associated with diffuse reflections), and/or one or more other types of acoustic simulation techniques. In some examples, a loss function 912 may be utilized to measure error of the energy histogram based on a comparison to ground truth energy histograms included in training samples. In some examples, the loss function 912 may be utilized to adjust one or more weights of the neural network and/or to generate one or more new ground truth energy histograms. For example, the loss function 912 may compute error between a rendered energy histogram (e.g., the energy histogram 860) and a ground truth energy histogram related to a training dataset for the audio environment. In some examples, the training flow 900 is executed repeatedly until training samples converge with a defined loss function value.

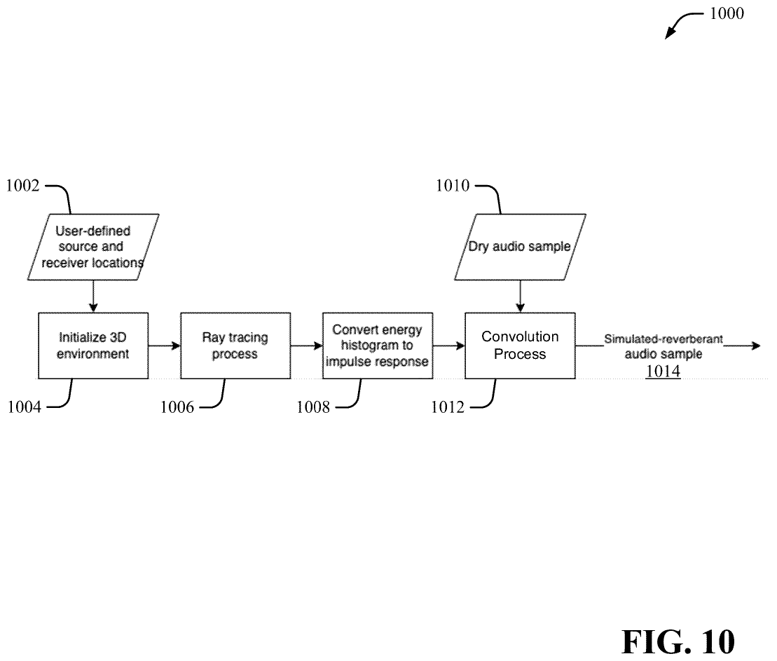

FIG. 10 illustrates an inference flow 1000 enabled by the neural acoustic modeling system 104 of FIG. 1 according to one or more embodiments of the present disclosure. The inference flow 1000 may be related to an inference pipeline for ray-traced neural acoustic modeling. With the inference flow 1000, user-defined source and receiver locations 1002 may be utilized to initialize a 3D environment via inference sub-flow 1004. The inference flow 1000 also includes a ray tracing process 1006 associated with acoustic simulation of the 3D environment. In some examples, the ray tracing process 1006 may generate audio ray information such as ray energy and/or total ray length. The ray tracing process 1006 may additionally or alternatively generate an energy histogram based on the audio ray information (e.g., ray energy and/or total ray length).

The inference flow 1000 also includes an inference sub-flow 1008 that converts the energy histogram into an impulse response set. Based on the impulse response set and one or more audio samples 1010 related to captured audio in the audio environment, a convolution process 1012 may be performed to generate a simulated-reverberant audio sample 1014. In some examples, the convolution process 1012 may receive as input an audio sample and an impulse response to produce an audio sample that simulates sound propagated between two locations in the audio environment. The impulse response may be for a source-receiver pair from an acoustic simulation. The simulated-reverberant audio sample 1014 may simulate what audio associated with the one or more audio samples 1010 would sound like if the sound of the one or more audio samples 1010 was propagated from the source to the receiver location in the audio environment. In some examples, a visualization related to learned surface material properties in the audio environment may be provided. In some examples, the learned surface material properties may be visualized by querying a trained network for each point on a surface viewed by a visual rendering of the audio environment. In some examples, visual characteristics (e.g., color) of surfaces may be configured according to coefficients of the surfaces. In some examples, the neural acoustic modeling inference data 111 includes the simulated-reverberant audio sample 1014 and/or the learned surface material properties.

In some examples, simulation and/or rendering of audio for a specific 3D environment may be provided by leveraging or augmenting a NeRF model to also output surface material properties (e.g., material classifications) for surfaces and/or objects in an environment. In some examples, a pre-defined lookup table is utilized to obtain known absorption coefficients from predicted material classifications. Using these absorption coefficients and geometry provided by a NeRF model, acoustic simulation and/or audio rendering techniques may be performed to synthesize impulse responses for source-receiver location pairs.

In some examples, an MLP of a NeRF model may be augmented to also output material classification in addition to RGB and volumetric density (e.g. drywall, painted concrete, window, etc.). The material classifications may be estimated for each 3D point and/or direction in the audio environment.

In some examples, a ground truth material classification may be obtained using a separate pre-trained network that segments collected images into material classifications. The ground truth material classifications may be coded as additional pixel channels. Given a camera position from the training set, a neural network may render pixels with the additional channels and/or compare respective renderings to the ground truth pixels. In some examples, material types may be integrated with audio rays to enhance alpha compositing for color information related to pixels.

In some examples, a lookup table may be queried to determine predicted materials for inferences related to an audio environment. The lookup table may include known materials and corresponding absorption coefficients. Using these absorption coefficients and the 3D geometry of the room, a simulation of the audio environment may be provided to render one or more impulse responses related to the audio environment.

In some examples, the convolution process 1012 may query the audio rendering model 105 for each reflection point of each ray traced through the 3D environment (e.g., each ray traced through the 3D environment from a source to a receiver) during the ray tracing process 1006. In some examples, an energy of a ray may be attenuated per frequency band based on inferred values provided by the audio rendering model 105. In some examples, a ray may contribute to a time-delayed energy arriving at a receiver location where a time delay is based on a length of a path of the ray and/or a speed of sound associated with the ray. In some examples, a length of a path may be utilized to attenuate energy of each ray to account for the impedance of air in the environment. In some examples, an energy of a ray may be transformed into an impulse response associated with a reflection point and/or a source to receiver pair.

In some examples, a user may select the user-defined source and receiver locations 1002 via an electronic interface of a user device to indicate a source and receiver pair for simulating acoustics between the user-defined source and receiver locations 1002. Additionally, the ray tracing process 1006 or another acoustic simulation process (e.g., an image source acoustic simulation process) may be performed to determine ray paths which propagate between the user-defined source and receiver locations 1002. Rays may reflect off one or more surfaces and/or objects within the audio environment during the propagation between the source and receiver locations. For example, the ray tracing process 1006 may determine a reflection point that correspond to a particular reflection off a surface and/or object within the audio environment.

For each ray, a position of each reflection point along a ray path may be encoded as a positional embedding. In some examples, respective encoded positions of a respective reflection point may be provided as input to a machine learning model such as, for example, the audio rendering model 105. Output of the machine learning model may include an absorption coefficient and/or a reflection coefficient per frequency band. In some examples, inferred absorption and/or reflection coefficients may be utilized to attenuate energy associated with a ray. Additionally, the attenuated energy may be modified based on a time delay, path length, and/or an impedance of air associated with the ray. In some examples, the attenuated energy may be transformed into an energy histogram for respective frequency bands. Additionally, the energy histograms may be transformed into an impulse response via the inference sub-flow 1008.

In some examples, reflection point data for an audio path (e.g., a ray) associated with the user-defined source and receiver locations 1002 may be determined via the ray tracing process 1006 or another acoustic simulation process associated with the audio environment. Additionally, a positional embedding associated with the audio path may be determined based on the reflection point data. The positional embedding may be provided as input to a machine learning model (e.g., the audio rendering model 105) configured to generate audio absorption characteristic data associated with the audio path. The audio absorption characteristic data may include absorption coefficients and/or a reflection coefficients per frequency band. Additionally, the simulated-reverberant audio sample 1014 associated with the audio environment may be determined based on the audio absorption characteristic data.

In some examples, energy data associated with the audio environment may be determined based on the audio absorption characteristic data. The energy data may include one or more energy histograms. Additionally, audio data associated with the audio environment (e.g., the one or more audio samples 1010) may be received. In some examples, the simulated-reverberant audio sample 1014 may be determined based on the energy data and the audio data.

In some examples, the audio path may be selected from a plurality of audio paths in the audio environment based on an association with respect to the receiver location of the user-defined source and receiver locations 1002. Additionally, the ray tracing process 1006 or another acoustics simulation process may be iteratively performed for multiple audio paths (e.g., one or more other audio paths of the plurality of audio paths) in the audio environment. In some examples, the plurality of audio paths may include hundreds, thousands, or another number of audio paths that may be received by a capture device located at the receiver location of the user-defined source and receiver locations 1002.

In some examples, the simulated-reverberant audio sample 1014 may be output via an audio output device. The audio output device may be an audio mixer device, a DSP processing device, a smartphone, a tablet computer, a laptop, a personal computer, an audio workstation device, a wearable device, an augmented reality device, a virtual reality device, a recording device, a microphone, headphones, earphones, speakers, a haptic device, or another type of output device.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce and/or be executed on specifically-configured machines performing the steps or operations specified in the block diagrams and flowchart illustrations. Accordingly, the block diagrams and flowchart illustrations support various combinations of embodiments for performing the specified instructions, operations, or steps.

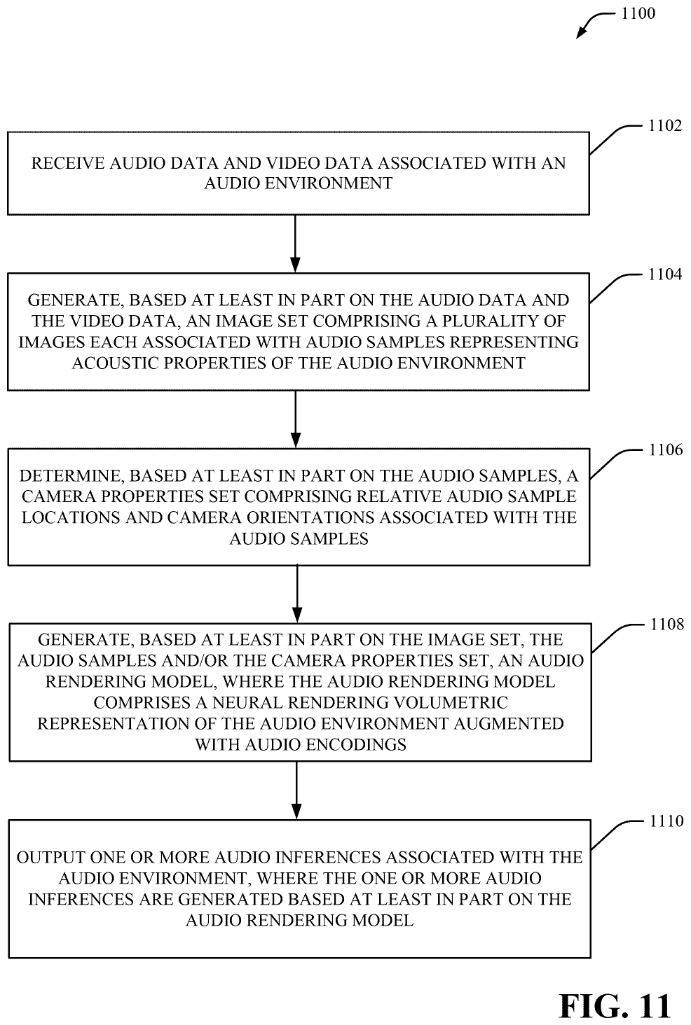

FIG. 11 is a flowchart diagram of an example process 1100, for providing neural acoustic modeling for an audio environment, in accordance with, for example, the neural acoustic modeling apparatus 202 illustrated in FIG. 2. Via the various operations of the process 1100, the neural acoustic modeling apparatus 202 may enhance quality and/or reliability of audio provided by an audio system.

The process 1100 begins at operation 1102 that receives (e.g., by the model generation circuitry 208) audio data and video data associated with an audio environment. The audio environment may be an indoor environment, an outdoor environment, a room, an auditorium, a performance hall, a broadcasting environment, an arena (e.g., a sports arena), a virtual environment, or another type of audio environment. In some examples, the audio data and the video data are respectively captured via at least one microphone and at least one camera of a capture device that scans the audio environment.

The process 1100 also includes an operation 1104 that, based at least in part on the audio data and the video data, generates (e.g., by the model generation circuitry 208) an image set comprising a plurality of images each associated with audio samples representing acoustic properties of the audio environment. In some examples, respective images may be correlated to respective impulse responses associated with the audio samples.

The process 1100 also includes an operation 1106 that, based at least in part on the audio samples, determines (e.g., by the model generation circuitry 208) a camera properties set comprising relative audio sample locations and camera orientations associated with the audio samples. In some examples, the camera properties set includes: a respective location of the image set with respect to the audio environment, a respective orientation of the image set with respect to the audio environment, photogrammetry information related to the image set, structure from motion information related to the image set, point cloud information related to the image set, and/or other information.

The process 1100 also includes an operation 1108 that, based at least in part on the image set, the audio samples and/or the camera properties set, generates (e.g., by the model generation circuitry 208) an audio rendering model, where the audio rendering model comprises a neural rendering volumetric representation of the audio environment augmented with audio encodings. The audio rendering model may be an audio rendering model for the audio environment. In some examples, the audio rendering model is a NeRF model augmented with audio encodings. In some examples, the image set, the audio samples, and/or the camera properties set are transformed into a data vector for input into the audio rendering model. In some examples, weights of the audio rendering model may be trained on volumetric probability densities which represent respective locations within the audio environment. The weights may be configured based at least in part on latent encoding of physical information and acoustic information for respective locations of the audio environment.

In some examples, a training data vector is input to the audio rendering model. The training data vector may include: image pixels for the set of images augmented with the camera properties set and the audio encodings, impulse responses for the set of images augmented with the camera properties set and the audio encodings, material acoustic properties for the set of images augmented with the camera properties set and the audio encodings, material types for the set of images augmented with the camera properties set and the audio encodings, and/or environmental measurements related to the audio environment. The material acoustic properties may be inferred from an acoustic classification network model. Additionally or alternatively, the material types may be inferred from an image classification network model.

The process 1100 also includes an operation 1110 that outputs (e.g., by the model inference circuitry 210) one or more audio inferences associated with the audio environment, where the one or more audio inferences are generated based at least in part on the audio rendering model. The outputting of the or more audio inferences may include outputting one or more portions of neural acoustic modeling inference data (e.g., neural acoustic modeling inference data 111) provided based on the audio rendering model (e.g., the audio rendering model 105). In some examples, outputting the one or more audio inferences includes outputting one or more candidate audio component locations associated with the audio environment, where the one or more candidate audio component locations are generated based at least in part on the audio rendering model.

In some examples, the audio rendering model is utilized to: infer locations of audio sources within the audio environment, infer acoustic attributes of sound emitted within or from the audio environment, generate a digital twin of the audio environment, generate an audio heat map of the audio environment, generate an audio simulation for the audio environment, generate a set of drawings or images of the audio environment along with optimal locations and/or audio settings of audio/video equipment within the audio environment, infer material attributes of objects or surfaces within the audio environment, and/or control audio equipment in the audio environment. In some examples, the material attributes may include: acoustic reflective, absorptive, transmissive, refractive, diffractive, frequency dependent, resonant, transmissive, non-linear, surface texture, material type, surface normal, surface geometry, absorption coefficients, and/or other attributes.

In some examples, inferences of the audio rendering model may be utilized to generate new training data for training one or more other neural rendering models. For example, the audio rendering model may be utilized to model reverberations in a different audio environment based on impulse responses for pairs of locations in the audio environment related to the audio rendering model. In another example, unprocessed audio and related simulated reverberant output may be utilized to generate a training sample for a machine learning model configured to perform dereverberation of audio.

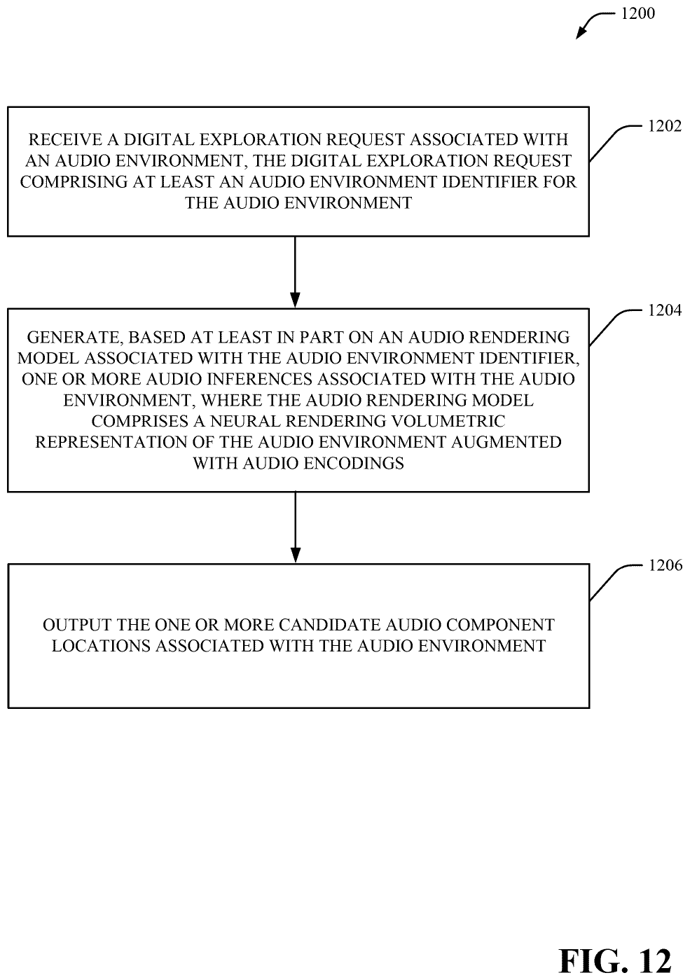

FIG. 12 is a flowchart diagram of an example process 1200, for providing audio inferences using neural acoustic modeling for an audio environment, in accordance with, for example, the neural acoustic modeling apparatus 202 illustrated in FIG. 2. Via the various operations of the process 1200, the neural acoustic modeling apparatus 202 may enhance quality and/or reliability of audio provided by an audio system.

The process 1200 begins at operation 1202 that receives (e.g., by the model inference circuitry 210) a digital exploration request associated with an audio environment, the digital exploration request comprising at least an audio environment identifier for the audio environment. In some examples, the digital exploration request is received from a user device.

The process 1200 also includes an operation 1204 that, based at least in part on an audio rendering model associated with the audio environment identifier, generates (e.g., by the model inference circuitry 210) one or more audio inferences associated with the audio environment, where the audio rendering model comprises a neural rendering volumetric representation of the audio environment augmented with audio encodings. In some examples, the audio rendering model is a NeRF model augmented with audio encodings. In some examples, the process 1100 additionally or alternatively includes generating one or more candidate audio component locations based at least in part on the audio rendering model.

The process 1200 also includes an operation 1206 that outputs (e.g., by the model inference circuitry 210) the one or more candidate audio component locations associated with the audio environment. In some examples, the process 1100 additionally or alternatively includes outputting the one or more candidate audio component locations associated with the audio environment. In some examples, the one or more candidate audio component locations include a candidate video component location. In some examples, the one or more candidate audio component locations correspond to respective three-dimensional coordinates of the audio rendering model. In some examples, an optimal location of an audio component in the audio environment may be determined based at least in part on the audio rendering model.

In some examples, the audio rendering model is utilized to: render a visual representation of the audio environment via a user interface, render a digital twin of the audio environment via a user interface, render audio heat map of the audio environment via a user interface, generate an audio simulation for the audio environment, infer acoustic attributes of sound emitted within the audio environment, and/or infer material attributes of objects or surfaces within the audio environment. In some examples, the material attributes may include: acoustic reflective, absorptive, transmissive, refractive, diffractive, frequency dependent, resonant, transmissive, non-linear, surface texture, material type, surface normal, surface geometry, and/or other attributes.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the processor, to cause the apparatus to: receive a digital exploration request associated with an audio environment, the digital exploration request comprising an audio environment identifier associated with the audio environment.

Clause 2. The apparatus of clause 1, wherein the instructions are further operable to cause the apparatus to: generate, based at least in part on an audio rendering model associated with the audio environment identifier, one or more candidate audio component locations.

Clause 3. The apparatus of any the aforementioned Clauses, wherein the audio rendering model comprises a neural rendering volumetric representation of the audio environment augmented with audio encodings.

Clause 4. The apparatus of any the aforementioned Clauses, wherein the instructions are further operable to cause the apparatus to: output the one or more candidate audio component locations associated with the audio environment.

Clause 5. The apparatus of any the aforementioned Clauses, wherein the audio rendering model comprises an augmented neural radiance field (NeRF) model.

Clause 6. The apparatus of any the aforementioned Clauses, wherein the one or more candidate audio component locations comprise a candidate video component location.

Clause 7. The apparatus of any the aforementioned Clauses, wherein the one or more candidate audio component locations correspond to respective three-dimensional coordinates of the audio rendering model.

Clause 8. The apparatus of any the aforementioned Clauses, wherein the instructions are further operable to cause the apparatus to: determine an optimal location of an audio component in the audio environment based at least in part on the audio rendering model.

Clause 9. The apparatus of any the aforementioned Clauses, wherein the instructions are further operable to cause the apparatus to: cause rendering, based at least in part on the audio rendering model, a visual representation of the audio environment via a user interface.

Clause 10. The apparatus of any the aforementioned Clauses, wherein the instructions are further operable to cause the apparatus to: cause rendering, based at least in part on the audio rendering model, a digital twin of the audio environment via a user interface.

Clause 11. The apparatus of any the aforementioned Clauses, wherein the instructions are further operable to cause the apparatus to: cause rendering, based at least in part on the audio rendering model, audio heat map of the audio environment via a user interface.

Clause 12. The apparatus of any the aforementioned Clauses, wherein the instructions are further operable to cause the apparatus to: generate, based at least in part on the audio rendering model, an audio simulation for the audio environment.

Clause 13. The apparatus of any the aforementioned Clauses, wherein the instructions are further operable to cause the apparatus to: generate, based at least in part on the audio rendering model, transfer function information for a source/listener pair within the audio environment.

Clause 14. The apparatus of any the aforementioned Clauses, wherein the instructions are further operable to cause the apparatus to: generate, based at least in part on the audio rendering model, training data for one or more other models.

Clause 15. The apparatus of any the aforementioned Clauses, wherein the instructions are further operable to cause the apparatus to: infer, based at least in part on the audio rendering model, acoustic attributes of sound emitted within the audio environment.

Clause 16. The apparatus of any the aforementioned Clauses, wherein the instructions are further operable to cause the apparatus to: infer, based at least in part on the audio rendering model, material attributes of objects or surfaces within the audio environment.

Clause 17. A computer-implemented method comprising steps related to any of the aforementioned Clauses.

Clause 18. A computer program product, stored on a computer readable medium, comprising instructions that, when executed by one or more processors of the apparatus, cause the one or more processors to perform one or more operations related to any of the aforementioned Clauses.

Clause 19. An apparatus comprising at least one processor and a memory storing instructions that are operable, when executed by the processor, to cause the apparatus to: receive audio data and image data associated with an audio environment.

Clause 20. The apparatus of clause 19, wherein the instructions are further operable to cause the apparatus to: generate, based at least in part on the audio data and the image data, an image set comprising a plurality of images each associated with audio samples representing acoustic properties of the audio environment

Clause 21. The apparatus of any the aforementioned Clauses, wherein the instructions are further operable to cause the apparatus to: determine, based at least in part on the audio samples, a camera properties set comprising relative audio sample locations and camera orientations associated with the audio samples.

Clause 22. The apparatus of any the aforementioned Clauses, wherein the instructions are further operable to cause the apparatus to: generate, based at least in part on the image set, the audio samples, and/or the camera properties set, an audio rendering model for the audio environment.

Clause 23. The apparatus of any the aforementioned Clauses, wherein the audio rendering model comprises a neural rendering volumetric representation of the audio environment augmented with audio encodings.

Clause 24. The apparatus of any the aforementioned Clauses, wherein the instructions are further operable to cause the apparatus to: output one or more candidate audio component locations associated with the audio environment.

Clause 25. The apparatus of any the aforementioned Clauses, wherein the one or more candidate audio component locations are generated based at least in part on the audio rendering model.

Clause 26. The apparatus of any the aforementioned Clauses, wherein the audio rendering model is an augmented neural radiance field (NeRF) model that is augmented with the audio encodings.

Clause 27. The apparatus of any the aforementioned Clauses, wherein the audio data and the image data are respectively captured via at least one microphone and at least one camera of a capture device that scans the audio environment.

Clause 28. The apparatus of any the aforementioned Clauses, wherein the camera properties set comprise a respective location and/or orientation of the image set with respect to the audio environment.

Clause 29. The apparatus of any the aforementioned Clauses, wherein the camera properties set comprise photogrammetry information related to the image set.

Clause 30. The apparatus of any the aforementioned Clauses, wherein the instructions are further operable to cause the apparatus to: transform the image set, the audio samples, and the camera properties set into a data vector for input into the audio rendering model.

Clause 31. The apparatus of any the aforementioned Clauses, wherein the instructions are further operable to cause the apparatus to: train weights of the audio rendering model on volumetric probability densities which represent respective locations within the audio environment.

Clause 32. The apparatus of any the aforementioned Clauses, wherein the weights are configured based at least in part on latent encoding of physical information and acoustic information for respective locations of the audio environment.

Clause 33. The apparatus of any the aforementioned Clauses, wherein the instructions are further operable to cause the apparatus to: train weights of the audio rendering model on color information related to respective locations within the audio environment.

Clause 34. The apparatus of any the aforementioned Clauses, wherein the instructions are further operable to cause the apparatus to: train weights of the audio rendering model on material properties of one or more objects within the audio environment.

Clause 35. The apparatus of any the aforementioned Clauses, wherein the instructions are further operable to cause the apparatus to: input, to the audio rendering model, a training data vector that comprises image pixels for the set of images augmented with the camera properties set and the audio encodings.

Clause 36. The apparatus of any the aforementioned Clauses, wherein the instructions are further operable to cause the apparatus to: input, to the audio rendering model, a training data vector that comprises impulse responses for the set of images augmented with the camera properties set and the audio encodings.

Clause 37. The apparatus of any the aforementioned Clauses, wherein the instructions are further operable to cause the apparatus to: input, to the audio rendering model, a training data vector that comprises material acoustic properties for the set of images augmented with the camera properties set and the audio encodings.

Clause 38. The apparatus of any the aforementioned Clauses, wherein the material acoustic properties are inferred from an acoustic classification network model.

Clause 39. The apparatus of any the aforementioned Clauses, wherein the instructions are further operable to cause the apparatus to: input, to the audio rendering model, a training data vector that comprises material types for the set of images augmented with the camera properties set and the audio encodings.

Clause 40. The apparatus of any the aforementioned Clauses, wherein the material types are inferred from an image classification network model.

Clause 41. The apparatus of any the aforementioned Clauses, wherein the instructions are further operable to cause the apparatus to: input, to the audio rendering model, a training data vector that comprises environmental measurements related to the audio environment.

Clause 42. The apparatus of any the aforementioned Clauses, wherein the instructions are further operable to cause the apparatus to: infer, based at least in part on the audio rendering model, locations of audio sources within the audio environment.

Clause 43. The apparatus of any the aforementioned Clauses, wherein the instructions are further operable to cause the apparatus to: infer, based at least in part on the audio rendering model, acoustic attributes of sound emitted within or from the audio environment.

Clause 44. The apparatus of any the aforementioned Clauses, wherein the instructions are further operable to cause the apparatus to: generate, based at least in part on the audio rendering model, a digital twin of the audio environment.

Clause 45. The apparatus of any the aforementioned Clauses, wherein the instructions are further operable to cause the apparatus to: generate, based at least in part on the audio rendering model, an audio heat map of the audio environment.

Clause 46. The apparatus of any the aforementioned Clauses, wherein the instructions are further operable to cause the apparatus to: generate, based at least in part on the audio rendering model, an audio simulation for the audio environment.

Clause 47. The apparatus of any the aforementioned Clauses, wherein the instructions are further operable to cause the apparatus to: generate, based at least in part on the audio rendering model, a set of drawings or images of the audio environment along with optimal locations and/or audio settings of audio/video equipment within the audio environment.

Clause 48. The apparatus of any the aforementioned Clauses, wherein the instructions are further operable to cause the apparatus to: infer, based at least in part on the audio rendering model, material attributes of objects or surfaces within the audio environment.

Clause 49. The apparatus of any the aforementioned Clauses, wherein the instructions are further operable to cause the apparatus to: control audio equipment in the audio environment based at least in part on the audio rendering model.

Clause 50. The apparatus of any the aforementioned Clauses, wherein the instructions are further operable to cause the apparatus to: receive a digital exploration request associated with the audio environment, the digital exploration request comprising an audio environment identifier associated with the audio environment.

Clause 51. The apparatus of any the aforementioned Clauses, wherein the instructions are further operable to cause the apparatus to: identify the audio rendering model based at least in part on the audio environment identifier.

Clause 52. The apparatus of any the aforementioned Clauses, wherein the instructions are further operable to cause the apparatus to: generate one or more audio inferences based at least in part on the audio rendering model.

Clause 53. The apparatus of any the aforementioned Clauses, wherein the instructions are further operable to cause the apparatus to: determine, based at least in part on the audio rendering model, one or more impulse responses associated with one or more audio sources in the audio environment.

Clause 54. A computer-implemented method comprising steps related to any of the aforementioned Clauses.

Clause 55. A computer program product, stored on a computer readable medium, comprising instructions that, when executed by one or more processors of the apparatus, cause the one or more processors to perform one or more operations related to any of the aforementioned Clauses.

Clause 56. An apparatus comprising at least one processor and a memory storing instructions that are operable, when executed by the processor, to cause the apparatus to: receive audio data and image data associated with an audio environment.

Clause 57. The apparatus of clause 56, wherein the instructions are further operable to cause the apparatus to: generate, based at least in part on the audio data and the image data, an impulse response set associated with audio samples representing acoustic properties of the audio environment.

Clause 58. The apparatus of any the aforementioned Clauses, wherein the instructions are further operable to cause the apparatus to: generate, based at least in part on the impulse response set and the audio samples, an audio rendering model.

Clause 59. The apparatus of any the aforementioned Clauses, wherein the audio rendering model comprises a neural rendering volumetric representation of the audio environment augmented with audio encodings.

Clause 60. A computer-implemented method comprising steps related to any of the aforementioned Clauses.

Clause 61. A computer program product, stored on a computer readable medium, comprising instructions that, when executed by one or more processors of the apparatus, cause the one or more processors to perform one or more operations related to any of the aforementioned Clauses.

Clause 62. An apparatus comprising at least one processor and a memory storing instructions that are operable, when executed by the processor, to cause the apparatus to: receive audio data associated with an audio environment.

Clause 63. The apparatus of clause 62, wherein the instructions are further operable to cause the apparatus to: generate an energy histogram associated with the audio data based on energy data related to the audio data.

Clause 64. The apparatus of any the aforementioned Clauses, wherein the instructions are further operable to cause the apparatus to: input to the energy histogram and the audio data to a machine learning model configured to generate a simulated-reverberant audio sample associated with the audio data.

Clause 65. The apparatus of any the aforementioned Clauses, wherein the instructions are further operable to cause the apparatus to: output the simulated-reverberant audio sample via an audio output device.

Clause 66. The apparatus of any the aforementioned Clauses, wherein the instructions are further operable to cause the apparatus to: query a three-dimensional (3D) model of the audio environment to generate surface information related to the audio environment.

Clause 67. The apparatus of any the aforementioned Clauses, wherein the instructions are further operable to cause the apparatus to: generate the energy histogram based on the surface information.

Clause 68. The apparatus of any the aforementioned Clauses, wherein the instructions are further operable to cause the apparatus to: input the energy histogram and the audio data to the machine learning model to generate a material classification for one or more surfaces within the audio environment.

Clause 69. A computer-implemented method comprising steps related to any of the aforementioned Clauses.

Clause 70. A computer program product, stored on a computer readable medium, comprising instructions that, when executed by one or more processors of the apparatus, cause the one or more processors to perform one or more operations related to any of the aforementioned Clauses.

Clause 71. An apparatus comprising at least one processor and a memory storing instructions that are operable, when executed by the processor, to cause the apparatus to: determine reflection point data for an audio path associated with a source location and receiver location in an audio environment based at least in part on an acoustic simulation process associated with the audio environment.

Clause 72. The apparatus of clause 71, wherein the instructions are further operable to cause the apparatus to: determine a positional embedding associated with the audio path based at least in part on the reflection point data.

Clause 73. The apparatus of any the aforementioned Clauses, wherein the instructions are further operable to cause the apparatus to: input to the positional embedding to a machine learning model configured to generate audio absorption characteristic data associated with the audio path.

Clause 74. The apparatus of any the aforementioned Clauses, wherein the instructions are further operable to cause the apparatus to: determine simulated-reverberant audio sample associated with the audio environment based at least in part on the audio absorption characteristic data.

Clause 75. The apparatus of any the aforementioned Clauses, wherein the instructions are further operable to cause the apparatus to: output the simulated-reverberant audio sample via an audio output device.

Clause 76. The apparatus of any the aforementioned Clauses, wherein the instructions are further operable to cause the apparatus to: determine energy data associated with the audio environment based at least in part on the audio absorption characteristic data.

Clause 77. The apparatus of any the aforementioned Clauses, wherein the instructions are further operable to cause the apparatus to: receive audio data associated with the audio environment.

Clause 78. The apparatus of any the aforementioned Clauses, wherein the instructions are further operable to cause the apparatus to: determine the simulated-reverberant audio sample based at least in part on the energy data and/or the audio data.

Clause 79. The apparatus of any the aforementioned Clauses, wherein the machine learning model is a multilayer perceptron model.

Clause 80. The apparatus of any the aforementioned Clauses, wherein the instructions are further operable to cause the apparatus to: determine a material classification for one or more surfaces within the audio environment based at least in part on the simulated-reverberant audio sample.

Clause 81. The apparatus of any the aforementioned Clauses, wherein the instructions are further operable to cause the apparatus to: query a three-dimensional (3D) model of the audio environment based on the simulated-reverberant audio sample to determine surface information related to the audio environment.

Clause 82. The apparatus of any the aforementioned Clauses, wherein the instructions are further operable to cause the apparatus to: select the audio path from a plurality of audio paths based on an association with respect to the receiver location.

Clause 83. A computer-implemented method comprising steps related to any of the aforementioned Clauses.

Clause 84. A computer program product, stored on a computer readable medium, comprising instructions that, when executed by one or more processors of the apparatus, cause the one or more processors to perform one or more operations related to any of the aforementioned Clauses.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising at least one processor and a memory storing instructions that are operable, when executed by the processor, to cause the apparatus to:
receive audio data and image data associated with an audio environment;
generate, based at least in part on the audio data and the image data, an image set comprising a plurality of images each associated with audio samples representing acoustic properties of the audio environment; and
generate, based at least in part on the image set and the audio samples, an audio rendering model for the audio environment, wherein the audio rendering model comprises a neural rendering volumetric representation of the audio environment augmented with audio encodings.

2. The apparatus of claim 1, wherein the audio rendering model comprises an augmented neural radiance field (NeRF) model that is augmented with the audio encodings.

3. The apparatus of claim 1, wherein the audio data and the image data are respectively captured via at least one microphone and at least one camera of a capture device that scans the audio environment.

4. The apparatus of claim 1, wherein the instructions are further operable to cause the apparatus to:
train weights of the audio rendering model on volumetric probability densities which represent respective locations within the audio environment, wherein the weights are configured based at least in part on latent encoding of physical information and acoustic information for respective locations of the audio environment.

5. The apparatus of claim 1, wherein the instructions are further operable to cause the apparatus to:
determine, based at least in part on the audio samples, a camera properties set comprising relative audio sample locations and camera orientations associated with the audio samples;
generate the audio rendering model based at least in part on the image set, the audio samples, and the camera properties set.

6. The apparatus of claim 5, wherein the camera properties set comprise a respective location of the image set with respect to the audio environment.

7. The apparatus of claim 5, wherein the camera properties set comprise a respective orientation of the image set with respect to the audio environment.

8. The apparatus of claim 5, wherein the instructions are further operable to cause the apparatus to:
input, to the audio rendering model, a training data vector that comprises impulse responses for the image set augmented with the camera properties set and the audio encodings.

9. The apparatus of claim 5, wherein the instructions are further operable to cause the apparatus to:
input, to the audio rendering model, a training data vector that comprises material acoustic properties for the image set augmented with the camera properties set and the audio encodings.

10. The apparatus of claim 1, wherein the instructions are further operable to cause the apparatus to:
determine, based at least in part on the audio rendering model, one or more impulse responses associated with one or more audio sources in the audio environment.

11. The apparatus of claim 1, wherein the instructions are further operable to cause the apparatus to:
infer, based at least in part on the audio rendering model, locations of audio sources within the audio environment.

12. The apparatus of claim 1, wherein the instructions are further operable to cause the apparatus to:
infer, based at least in part on the audio rendering model, acoustic attributes of sound emitted within or from the audio environment.

13. The apparatus of claim 1, wherein the instructions are further operable to cause the apparatus to:
output one or more candidate audio component locations associated with the audio environment, wherein the one or more candidate audio component locations are generated based at least in part on the audio rendering model.

14. The apparatus of claim 1, wherein the instructions are further operable to cause the apparatus to:
generate, based at least in part on the audio rendering model, a digital twin of the audio environment.

15. The apparatus of claim 1, wherein the instructions are further operable to cause the apparatus to:
generate, based at least in part on the audio rendering model, an audio heat map of the audio environment.

16. The apparatus of claim 1, wherein the instructions are further operable to cause the apparatus to:
generate, based at least in part on the audio rendering model, an audio simulation for the audio environment.

17. The apparatus of claim 1, wherein the instructions are further operable to cause the apparatus to:
control audio equipment in the audio environment based at least in part on the audio rendering model.

18. The apparatus of claim 1, wherein the instructions are further operable to cause the apparatus to:
infer, based at least in part on the audio rendering model, material attributes of objects or surfaces within the audio environment.

19. The apparatus of claim 1, wherein the instructions are further operable to cause the apparatus to:
generate, based at least in part on the audio rendering model, a set of drawings or images of the audio environment along with optimal locations or audio settings of audio equipment within the audio environment.

20. The apparatus of claim 1, wherein the instructions are further operable to cause the apparatus to:
receive a digital exploration request associated with the audio environment, the digital exploration request comprising an audio environment identifier associated with the audio environment;
identify the audio rendering model based at least in part on the audio environment identifier; and
generate one or more audio inferences based at least in part on the audio rendering model.

21. A computer-implemented method comprising:
receiving audio data and image data associated with an audio environment;
generating, based at least in part on the audio data and the image data, an image set comprising a plurality of images each associated with audio samples representing acoustic properties of the audio environment; and
generating, based at least in part on the image set and the audio samples, an audio rendering model for the audio environment, wherein the audio rendering model comprises a neural rendering volumetric representation of the audio environment augmented with audio encodings.

22. A computer program product, stored on a computer readable medium, comprising instructions that, when executed by one or more processors of an apparatus, cause the one or more processors to:
receive audio data and image data associated with an audio environment;
generate, based at least in part on the audio data and the image data, an image set comprising a plurality of images each associated with audio samples representing acoustic properties of the audio environment; and
generate, based at least in part on the image set and the audio samples, an audio rendering model for the audio environment, wherein the audio rendering model comprises a neural rendering volumetric representation of the audio environment augmented with audio encodings.
